(19) United States
(12) Patent Application Publication
(10) Pub. No.: US 2014/0255270 A1
(43) Pub. Date: Sep. 11, 2014

(54) REMOVING SACRIFICIAL LAYER TO FORM LIQUID CONTAINMENT STRUCTURE AND METHODS OF USE THEREOF

(71) Applicant: California Institute of Technology, Pasadena, CA (US)

(72) Inventors: Penvipha Satsanarukkit, Pasadena, CA (US); Michael R. Hoffmann, South Pasadena, CA (US)

(21) Appl. No.: 14/194,639

(22) Filed: Feb. 28, 2014

Related U.S. Application Data
(60) Provisional application No. 61/770,532, filed on Feb. 28, 2013.
(60) Provisional application No. 61/807,255, filed on Apr. 1, 2013.

(51) Int. Cl. B01L 3/00

(52) U.S. Cl. CPC B01L 3/502707
USPC 422/502; 427/226

(57) ABSTRACT

A method of forming a liquid handling device includes forming a device precursor having a containment structure with a surface that surrounds a containment gap that is occupied by a solid sacrificial layer. The method also includes removing the solid sacrificial layer from the containment gap. In some instances, removing the solid sacrificial layer includes thermally decomposing the solid sacrificial layer.

### CROSS REFERENCE TO RELATED APPLICATIONS

This application claims the benefit of U.S. Provisional Patent Application 61/770,532, filed on Feb. 28, 2013, entitled “Portable Parylene Biosignatures Detection System” and also of U.S. Provisional Patent Application 61/807,255, filed on Apr. 1, 2013, entitled “Portable Integrated Parylene Sample Concentration and Preparation Device for PCR,” each of which is incorporated herein in its entirety.

### FIELD OF THE INVENTION

The disclosure relates to fluid handling systems and more particularly to the use of decomposition in fabrication of fluid handling systems.

### BACKGROUND

Microfluidics systems are used to handle small volumes of fluids. One possible application of these systems is testing small samples for the presence and/or amount of an analyte. These systems often require a variety of fluid handling components including, but not limited to, reservoirs, channels for transportation of liquids to and/or from these reservoirs, mixers for mixing different liquids, and reactors for carrying out reactions in these liquids. These components often have complicated features with dimensions on the order of several microns. As a result, fabrication of these is often associated with a variety of challenges such as unusually long fabrication times and separation of the different component parts. Accordingly, there is a need improved microfluidic systems.

### SUMMARY

A liquid handling device includes a containment structure with a surface that defines a containment gap. A longitudinal axis of the containment gap being is located in the containment gap and is parallel to a direction that the liquid flows through the containment gap during operation of the device. The containment gap surrounds the longitudinal axis. A method of generating the liquid handling device includes forming a device precursor having the containment gap occupied by a solid sacrificial layer and then removing the solid sacrificial layer from the containment gap.

Another embodiment of the liquid handling device has a containment structure with a surface that defines a containment gap. The containment gap is structured so a first plane can be located such that an intersection of the first plane and the containment structure surrounds the containment gap. The containment gap is also structured so a second plane that is perpendicular to the first plane can be located such that an intersection of the second plane and the containment structure surrounds the containment gap. A method of generating the liquid handling device includes forming a device precursor having the containment gap occupied by a solid sacrificial layer and then removing the solid sacrificial layer from the containment gap.

The containment structure can include, consist essentially of, or consist of a sacrificial polymer and/or the sacrificial layer can include, consist essentially of, or consist of a containment polymer. In some instances, the sacrificial polymer is a polypropylene-carbonate and/or the containment polymer is a parylene, such as Parylene-D.

In a particular embodiment, the disclosure provides for a concentration and/or preparation device which comprises parylene based liquid channel, wherein at least a portion of the parylene channel is semipermeable to gases. In a further embodiment, at least a portion of the parylene channel is hydrophobic and at least another portion is hydrophilic.

In a certain embodiment, the disclosure provides for a parylene based PCR on-chip device. In another embodiment, the PCR on-chip device comprises a parylene fluid channel that can perform a PCR thermocyling reaction by being in thermal contact with one or more heating elements. In a further embodiment, the PCR on-chip device is clamp packaged to prevent bubble formation and leakage during PCR thermocycling. In yet a further embodiment, the one or more heating elements are solar powered. In another embodiment, the PCR on-chip device comprises SAP based bioreactors.

In a particular embodiment, the disclosure provides for a parylene based all in one PCR on-chip device that comprises a sample region that allow for inputting a sample; a sample preparation region that allows for concentrating the sample, DNA extraction and purification; and a PCR region that allows for thermosiphon dPCR; wherein the fluid channels are comprised of parylene. In a further embodiment, the sample inputted into the sample region is first combined with PMA and then inputted into the sample region and exposed to artificial light or sunlight. In yet a further embodiment, the sample preparation region comprises preloaded CPM beads. In another embodiment, the PCR region comprises SAP containing PCR reagent. In yet another embodiment, the parylene based all in one PCR on-chip device heating elements are solar powered. In a further embodiment, the parylene based all in one PCR on-chip device is used in conjunction with a solar toilet to detect and quantitate microbes or viruses in wastewater or drinking water.

### BRIEF DESCRIPTION OF THE FIGURES

FIG. 1A-E illustrate a method of forming a microfluidics device having a fluid containment gap. (A) is a cross section of a device precursor having a first containment layer on a substrate. (B) is a cross section of the device precursor having a sacrificial layer on the first containment layer. (C) is a cross section of the device precursor after patterning of the sacrificial layer. (D) is a cross section of the device precursor with a second containment layer contacting and covering the first containment layer such that the sacrificial layer is located in a containment gap defined by surfaces of the first containment layer and the second containment layer. (E) is a cross section of a device that results from removing the sacrificial layer from the device precursor of (D).

FIG. 2A-C illustrate a portion of a microfluidics device constructed using the method of FIG. 1A-E. (A) is a topview of the microfluidics device. (B) is a cross section of the device shown in (A) taken along the line labeled B in (A). (C) is a cross section of the device shown in (A) taken along the line labeled C in (A). (D) is a topview of a portion of a microfluidic processing device having a transport channel.

FIG. 3A-D illustrates application of the method of FIG. 1A-E to the formation of a freestanding device. (B) is a perspective view of a device that results from the method illustrated in (A). (C) is a cross section of the device shown in (B) taken along the plane labeled C in (B). (D) is a cross section of the device shown in FIG. 3B taken along the plane labeled D in (B).

FIG. 4A-C illustrate application of the method of FIG. 1A-E to the formation of a device without a substrate that serves as a base. (A) is a perspective view of a rod of a sacrificial layer. (B) is a cross section of the sacrificial layer after formation of a containment layer on the sacrificial layer. (C) is a cross section of a fluid conduit that results from the removal of the sacrificial layer from within the containment layer. (D) is a perspective view of a liquid flow structure that can be fabricated using the fluid conduit from (C).

FIG. 5 presents a parylene based evaporating concentrating device.

FIG. 6 shows that parylene can be patterned to have hydrophobic or hydrophilic properties in order to concentrate fluid in certain portions of the concentrator device.

FIG. 7 shows that parylene can be varied to have select gas permeability so as to allow for evaporation only in certain portions of the concentrator device.

FIG. 8 provides for a free-standing Parylene device prior to in situ membrane integration. Top: free-standing 20 μm thick parylene cassette body compared with glass slide (W×H×H: 50 mm×75 mm×1 mm; Volume ˜3.75 mL). Bottom left: parylene loaded with ˜3.75 mL of food color showing no leakage and no collapsing. Bottom right: shows that the hydrophobic portion is devoid of fluid.

FIG. 9A-G provides a scheme to fabricate a parylene based PCR chip: (A) Oxide is grown and patterned on silicon; (B) the backside of the silicon is DRIE etched; (C) a first layer of parylene is deposited and patterned on the silicon; (D) the frontside of the silicon is DRIE and XeF₂ etched; (E) a second layer of parylene is deposited and patterned on the chip; (F) platinum is deposited and liftoff patterned; and (G) the backside of the CHIP is DRIE and XeF₂ etched.

FIG. 10 presents a parylene based on-chip PCR device.

FIG. 11 provides for loading the on-chip PCR device of FIG. 10 by manually injecting the sample using a gas-tight microsyringe.

FIG. 12 demonstrates the heating dynamics for the parylene based on-chip PCR device of FIG. 10.

FIG. 13 presents the temperature coefficient of resistance of the parylene based on-chip platinum sensor.

FIG. 14 provides a curve of the input power of the initiation and the first 3 thermal cycles for a parylene based PCR on-chip of FIG. 10.

FIG. 15 provides a curve of the temperature profiles of the initiation and the first 3 thermal cycles.

FIG. 16 provides gel electrophoresis images: (top) standard polypropylene tubes of volumes of 1, 2, 2, 3, and 3 μL and (bottom) standard polypropylene coated with 15 μm of parylene-C of volume 2, 2, 3, 3 μL, and No Template Control (NTC) using a standard thermal cycler.

FIG. 17A-F provides on-chip fluorescence images of 90 pg intial template after cycle: (A) 0^{th}; (B) 10^{th}; (C) 20^{th}; (D) 30^{th}; (E) 40^{th}; and (F) 50^{th} for the PCR on-chip device of FIG. 10.

FIG. 18 provides for on-chip fluorescence intensities: (1) 6 pg initial template; (2) 90 pg initial template, and (3) No Primer Control.

FIG. 19A-G provides a scheme to fabricate a freestanding and flexible free-standing parylene-C micro-PCR channel using photoresist as a sacrificial layer. (A) Deposit 10-micron parylene C on a silicon substrate; (B) Spin and pattern sacrificial photoresist; (C) Deposit 10-micron parylene C; (D) Spin and pattern 100-micron SU-8 50; (E) Open the ports using laser ablation; (F) Release sacrificial photoresist; and (G) Release device from the silicon substrate

FIG. 20A-B presents images of the free-standing parylene-C micro-PCR channel. Each micro-PCR channel film contains two 100-micron wide channels. (A) after diluted food color loading; and (B) after PCR solution loading and clamping.

FIG. 21A-B presents radiance and temperature images of microchannels filled with PCR solution that has been heated to 95° C. The radiance images which depend on the material were recorded every 5 minutes to observe if any air bubble happening. (A) after 40 minutes; and (B) after 300 minutes. The images show the uniformity of temperature distribution at 95° C. with the PCR solution filled in the channels. The air bubble spot on the left hand side of the channels in the radiance images helped to identify if there was any leaking.

FIG. 22 presents a calculated curve of resistance for a 20 nm Ti/200 nm Pt microsensor on 10-micron parylene C characteristics. The TCR is 1.6E-3/° C.

FIG. 23 provides selected transient infrared thermal 1× magnification image characterization for the complete on-chip device comprising the free-standing parylene-C micro-PCR channel of FIG. 20 with the input power of 21 to 30 mW respectively. The integrated device demonstrated a uniform heating area in the fluorescence detecting zone.

FIG. 24 presents a curve of the micro-PCR amplification fluorescence as a function of the number of cycles with the starting of about 100 molecules of templates in approximate 2 nL volume in the fluorescence detecting zone. The PCR curve was plot against the ROX passive reference dye injected into the parallel second channel with 150 micron apart from the PCR channel.

FIG. 25 provides a flow schematic comparing the steps of traditional qPCR-PMA with a solar powered microfluidic platform of the disclosure.

FIG. 26 presents a PMA™ based method for viable cell quantification. PMA™ is a photo-reactive dye with a high affinity for DNA. Because PMA™ is designed to be cell membrane-impermeable, when a sample comprising both live and dead bacteria is treated with PMA™, only dead bacteria are susceptible to DNA modification due to compromised cell membranes. Thus, subsequent lysis of live bacteria followed by qPCR permits selective detection of the live cells. The PMA™-qPCR technology can be applied not only to bacteria but to other microbial cell types as well.

FIG. 27 shows that PMA™ intercalates into dsDNA and forms a covalent linkage upon exposure to intense visible light, resulting in chemically modified DNA, which cannot be amplified by PCR.

FIG. 28 presents solar cells which can power the PCR on-chip for live bacterial quantification. In one embodiment, the system uses 7.8 watts from six 6V solar panels for the PCR reactor and temperature controller.

FIG. 29 provides a bar chart showing the optimization for tracking sunlight over various angles relative to incident light. The DC motor turns at 0.5V.

FIG. 30 provides a comparison of PMA treatment using halogen lamps and sunlight. Due to the similar results, sunlight can be used for PMA photolysis, eliminating the need for artificial light.

FIG. 31 presents a comparison of DNA extraction using Qiagen and CPM beads with heating at 100° C. For Qiagen protocol, there is not much difference in Ct for each sample concentration. This may be because DNA is lost during sample concentration. (1) Halogen-100% cells; (2) Halogen-10% cells-90% DNA; (3) Halogen-100% DNA; (4) Sunlight-100% cells; (5) Sunlight-10% cells-90% DNA; (6) Sunlight-100% DNA; (7) 100% cells; (8) 10% cells-90% DNA; (9) 100% DNA; (10) NTC; and (11) NPC.

FIG. 32 provides an overview of the many uses of parylene based materials including for sample preparation, pre-PCR incubators, PCR on-chips, reagent storage, waste management, and product storage.

FIG. 33 provides images of a free-standing parylene-D SPE column. (left) image of Weir-type frit, (center) 10 μm beads loaded in 350 μm Parylene column, (right) parylene SPE column array. For packing: by slowing the flowrate of bead-slurry, one can minimize voiding and channeling; and by using high pressure at the end of the column, the packing can be tighten.

FIG. 34 provides for on-chip waste management utilizing the parylene based evaporating concentrating device of FIG. 5. Parylene and super absorbent polymer (SAP) allow for high load capacity but light weight. Paralyene reservoirs are filled with SAP on an integrated heater in order to evaporate water medium. SAP has superior speed and adsorption capacity (e.g., D1 water>490 (g/g); blood/saline>25 (g/g), is well known as a waste lock for medical use, and can confine dangerous/infectious substances. The on-chip waste management system can be designed to allow for tight packing/stacking, and is easy to fabricate, use and store.

FIG. 35 provides images of free-standing 2D parylene filters. The wafers are 4-inches in area, have 10 and 8 μm top and bottom hole sizes with a 30 μm pitch and a 10 μm thickness.

FIG. 36 provides images of parylene based reservoirs. The reservoirs are inert; evaporation minimized; light-weight; easy to fabrication; use and pack; and can be designed for tight packing/stacking. In comparison to other reservoirs, the 40 μm parylene reservoirs are made with the thinnest materials, can stack many reservoirs in a tight limited space, and has a utility rate in excess of 98%.

FIG. 37 provides a generalized schematic of a paralyene based PCR chip device that is comprised of multiple zones, including (1) PMA photoactivation by light zone, (2) sample concentration and DNA purification zone, and (3) a thermosiphon digital PCR zone.

FIG. 38 provides images of thermally-released sacrificial layers of parylene-D and polypropylene carbonate (PPC). The branches consist of 20, 40 and 100 μm wide channels, and 40 μm posts.

FIG. 39 provides images of thermally-released sacrificial layers of parylene-D and PPC. The bars are 100, 100, 20, 100 and 100 microns respectively.

FIG. 40 diagrams the 3D flow-through parylene device based upon solid sacrificial layer technology. Solid wire is selected with a desired OD, which is them primed with micro-90, and coated with parylene. The parylene device is taken out and coiled at T>T_{g}.

FIG. 41 provides a diagram of a portable microbial monitoring system that could evaluate or monitor the efficiency of the wastewater treatment before the dispose of the treated effluent to drain or to reuse.

FIG. 42 provides a comparison of viable bacteria quantification protocols. The Parylene-D device is capable of performing PMA treatment, sample concentration, and DNA extraction in a single step.

FIG. 43 provides a listing of common pathogenic viruses and organisms found in wastewater and drinking water.

FIG. 44 presents the fabrication of a parylene-D sample processing unit. The transparency of parylene film allows PMA photolysis. Facile pore fabrication and the free-standing structure allow for easy concentration of the sample. With sunlight and Fresnel lens setup, the device readily performs DNA extraction and purification. Parylene thickness 25-25 um; pore size 70-100 um. Rightmost panel shows nested parylene films.

FIG. 45 provides for a foldable PV-powered system with an automatic solar tracker integrated on the left and a microfluidic chip designed to fit a 34 cm×24 cm×7 cm box.

FIG. 46 presents a microfluidic chip design for live helminth eggs; total bacteria (16S) and enterococcus; and polioviruses (Serotype1, Serotype2, Serotype3, PanPV, PanEV, and Sabin) monitoring. The chip has the size of 8.15 cm×11.65 cm×1.5 cm. No pump and valve are needed. The system has 5 heaters and 5 temperature controllers underneath and requires less than 10 watts of power.

FIG. 47 provides a schematic of a SAP compatability test with PCR. PCR components were separated into three groups: DNA template; primers and Taqman probe; and the last group containing: Supermix, Rox dye, and RNase/DNase free water. SAP-PCR compatibility was tested in four situations: (1) Immobilized DNA into SAP and then encapsulated the second and third groups (potentially for the flexibility of multiple primers testing); (2) Immobilized forward and reverse primers and Taqman probe into SAP and then encapsulated the first and the third groups (potentially as SAP DNA detectors); (3) Immobilized all reagents into SAP at the same time; (4) Pure SAP to observe the background noise; (5) Positive control (No SAP); (6) Negative control (No template control). Three standards were used to investigate the SAPPCR compatibility.

FIG. 48 provides qPCR amplification results from Stratagene Mx3000 qPCR. The samples No. 1, 2, 3, 5 contain same amount 2.4 ng of 18S rRNA template. One reaction contains 5 uL PCR reagents and 10 uL PCR oil. From the qPCR amplification curve, Ct are 14.95, 15.18, 15.48, 0, 14.32, and 0 for 1) Pre-immobilized DNA; 2) Pre-immobilized primers and probe; 3) Immobilized all reagents into SAP at the same time; 4) Pure SAP; 5) Positive control (No SAP); and 6) Negative control, respectively. The Ct values of the samples No. 1, 2, 3, 5 are very similar and show the compatibility of using SAP with PCR in various types of initial reagent immobilization.

FIG. 49A-C provides fluorescence images with the blue excitation from Nikon Fluorescence microscope of 1 uL on glass slides of (A) Pure SAP in DI water, (B) SAP-Visiblue-PCR before PCR, and (C) SAPVisiblue-PCR after qPCR. Fluorescence images having green emissions imply positive DNA amplification in SAP bioreactors resulting from increasing amounts of FAM labeled DNA product.

FIG. 50 presents qPCR amplification results of SAP, Visiblue and PCR compatibility test from Stratagene Mx3000. 18S rRNA template of 1, 10, and 100 pg were immobilized in 0.5 uL SAP. One reaction contains 2 uL PCR reagent and 10 uL PCR oil. Visiblue was investigated for easy loading, visualizing and detecting on-chip. The qPCR results confirm that SAP and visiblue are compatible with PCR.

FIG. 51 presents Flow cytometric histograms of SAP bioreactors carrying the FAM labeled PCR products with starting 1, 10, and 100 pg of 18S rRNA template encapsulated. Each red dot above the background represents one positive SAP bioreactors.

FIG. 52 presents examples of parylene chip Plug-and-Play fluidic I/O technology developed herein. The Plug-and-Play technology allows for easy and fast connection; direct to external coupling; no solid work, machines or jigs are needed; clog free assembly; and is chemical resistant. Moreover, the technology can be designed to fit commercial SS connectors and Luer hubs, and is easy to integrate with on-chip channels. Finally, the technology can be used to easily connect several devices together.

FIG. 53A-C presents method for in situ parylene based Plug-and-Play Fluidic I/O Technology. (A) A parylene based on-chip can be produced by using polypropylene carbonate as an intermediate according to steps I to V. (B) PPC rods are fabricated that have the same size as stainless tubing that will be used. The PPC is melted and drawn into a non-stick high-operating temperature polymer tubing that has an ID size the same as the OD size of the stainless tubing. (C) The PPC rods are cooled and the polymer tubing is peeled away. The rods are then attached to the port on the chip during step III of the chip fabrication process. The chip process is then followed to step V.

### DETAILED DESCRIPTION

As used herein and in the appended claims, the singular forms “a,” “and,” and “the” include plural referents unless the context clearly dictates otherwise. Thus, for example, reference to “a polynucleotide” includes a plurality of such polynucleotides and reference to “the microorganism” includes reference to one or more microorganisms, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Any publications discussed above and throughout the text are provided solely for their disclosure prior to the filing date of the present application. Nothing herein is to be construed as an admission that the inventors are not entitled to antedate such disclosure by virtue of prior disclosure.

Fluid handling devices can be fabricated by forming a device precursor having a containment gap that is supposed to hold liquid during operation of the final device. The device precursor includes a containment structure having a surface that surrounds the containment gap. A solid sacrificial layer can be located in the containment gap. The sacrificial layer can be removed from the containment gap so as to provide a containment gap in which a liquid can be positioned. Suitable methods for removing the sacrificial layer include, but are not limited to, decomposition methods such as thermal decomposition. Further, the use of thermal decomposition can remove or reduce the need to use organic solvents to remove various layers of the device. Organic solvents are a source of device delamination and can have an undesirably effect on particular materials. For example, traditional Parylene microfluidic process, the sacrificial photoresist takes too long to release. It has been reported that the dissolution of sacrificial photoresist takes about 30 minutes/millimeter dissolution distance in acetone regardless of the cross-sectional dimensions of the channel. Moreover, long channels and complicated microstructures make the release of the sacrificial photoresist unrealistically long and nearly impossible. Additionally, during the long photoresist release, the solvent (e.g., acetone) attacks and swells the structural material, and weakens the adhesions between the structural material and the substrate. Swollen structures cause mechanical and functional problems. Poor adhesion to the substrate all too often causes the structure's delamination off the substrate. The Parylene-D-PPC technology eliminates these issues. Further, the surfaces that define the containment gap need not be etched. As a result the fabrication method of the disclosure can reduce fabrication difficulty.

In some instances, the surfaces of the containment gap are defined by a parylene and the sacrificial layer is a polypropylene carbonate. This combination of materials has been surprisingly successful at low decomposition temperatures and has generated microfluidic channels with small features such as pillars or posts, long length channels, high quality channel junctions, and complex branching structures. As a result, this device fabrication method can increase device quality.

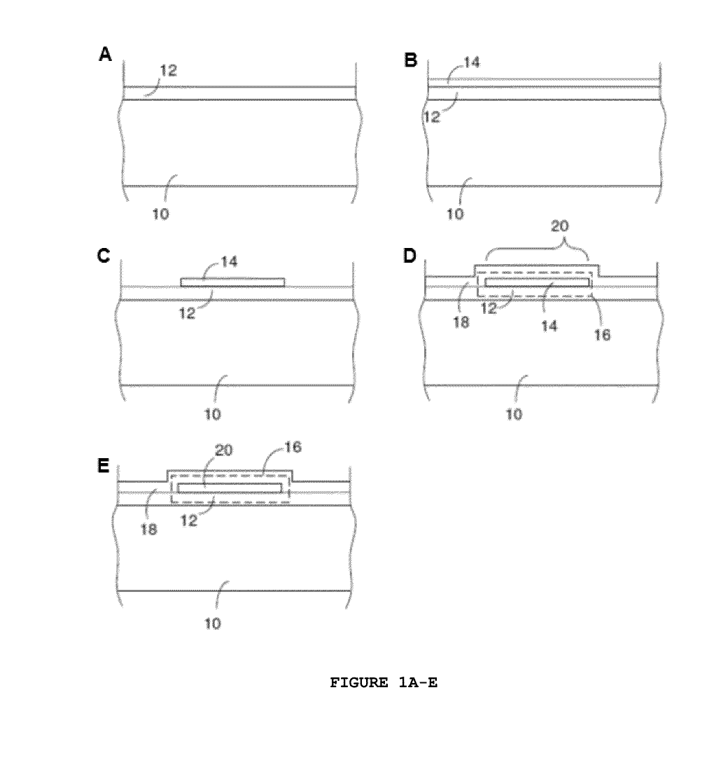

FIGS. 1A-E illustrate a method of forming a microfluidic device having a fluid containment gap. FIG. 1A is a cross section of a device precursor. The device precursor includes a substrate 10 that will serve as a base for the device. Suitable materials for the substrate 10 include, but are not limited to, silicon. A first containment layer 12 is formed on the substrate 10. Suitable methods for forming the first containment layer 12 on the substrate 10 include, but are not limited to, deposition and coating. Suitable methods for deposition of the first containment layer 12 include, but are not limited to, vapor deposition methods such as Chemical Vapor Deposition (CVD).

A sacrificial layer 14 is formed on the device precursor of FIG. 1A so as to provide the device precursor of FIG. 1B. A suitable method of forming the sacrificial layer on the device precursor includes, but is not limited to, coating and deposition. A suitable method of coating the sacrificial layer on the device precursor include, but is not limited to, spin coating. The sacrificial layer on the device precursor of FIG. 1B is patterned so as to provide the device precursor of FIG. 1C. Suitable methods of patterning the sacrificial layer 14 include, but are not limited to, photolithography. Accordingly, patterning of the sacrificial layer 14 can include forming a photoresist on the device precursor in the pattern desired for the sacrificial layer 14 followed by etching of the device precursor and removal of the photoresist.

A second containment layer 18 is formed on the device precursor of FIG. 1C so as to provide the device precursor of FIG. 1D. The second containment layer 18 is formed over the sacrificial layer and can be in direct physical contact with the sacrificial layer 14. For instance, the second containment layer 18 can both cover and be in contact with the top and lateral sides of the sacrificial layer. The second containment layer 18 is also over the regions of the second containment layer 18 that are not protected by the sacrificial layer 14. Accordingly, the second containment layer 18 can be in direct physical contact with the first containment layer 12.

The device precursor includes a containment structure 16 having a surface that surrounds the sacrificial layer 14 and is in direct physical contact with the sacrificial layer 14. The containment structure 16 includes or consists of at least a portion of the first containment layer 12 and at least a portion of the second containment layer 18. For instance, the surface of the containment structure 16 that surrounds the containment gap 20 includes or consists of a surface of the first containment layer 12 and a surface of the second containment layer 18. Suitable methods for forming the second containment layer 18 on the device precursor include, but are not limited to, deposition and coating. Suitable methods for deposition of the second containment layer 18 include, but are not limited to, vapor deposition methods such as Chemical Vapor Deposition (CVD). The first containment layer 12 and the second containment layer 18 can be constructed of the same material or from different materials. When the first containment layer 12 and the second containment layer 18 are constructed of the same material, the result can be a single continuous material where the interface of the first containment layer 12 and the second containment layer 18 is not readily discernable.

The sacrificial layer 14 is removed from the containment gap 20 in the device precursor of FIG. 1D so as to provide the device of FIG. 1E. Suitable methods of removing the sacrificial layer include, but are not limited to, decomposing the sacrificial layer 14. In some instances, thermal decomposition is employed to remove the sacrificial layer 14. Thermal decomposition can be a process by which the sacrificial layer 14 is broken down into simpler units by the application of heat. The thermal decomposition can be a chemical process which involves the breaking of chemical bonds in the sacrificial layer 14. Suitable temperatures for the thermal decomposition include, but are not limited to, temperatures less than 300° C. or 250° C. Because methods such as thermal decomposition can generate a gas in the containment gap 20, it may be necessary to provide a mechanism for venting the gaseous result of thermal decomposition to the atmosphere. The result is a device where the containment structure 16 defined by the first containment layer 12 and the second containment layer 18 surrounds a containment gap 20 that is filled with a gas, liquid, or fluid. The gas is generally the same or substantially the same as the ambient atmosphere in which the device is located.

The formation of the first containment layer 12 is optional. For instance, the sacrificial layer 14 and the second containment layer 18 can be formed directly on the substrate 10. Accordingly, a surface of the substrate 10 can define a portion of the containment gap 20 and the second containment layer 18 can be in direct contact with the substrate. Further, a wafer that includes or consists of the first containment layer 12 can serve as the substrate.

The device formation method can be used in a variety of different applications such as microfluidic processing devices. These devices are generally portable and small enough to be used in the field. They often have a card or cartridge shape and/or size. In some examples, microfluidic processing devices are configured to perform an assay, perform electrochemical experiments on an example, reacts components in different liquids, synthesize a compound, and/or prepare liquid for any of the above purposes. Accordingly, these microfluidic processing devices often include a variety of liquid handling components such as reservoirs for storing or testing liquids, channels for transportation of liquids to and/or from these reservoirs, mixers for mixing different liquids, valves for controlling liquid flow, and reactors for carrying out reactions in these liquids. Additionally or alternately, these microfluidic processing devices can optionally include one or more active components selected from a group consisting of one or more electrodes, one or more sensors, and one or more temperature control devices. Examples of electrodes include the electrodes use in electrophoresis and the working, counter and reference electrodes used in voltammetry or cyclic voltammetry or. Examples of sensors include ph sensors, temperature sensors, conductivity sensors. Examples of temperature control devices include, but are not limited to, resisting heating elements.

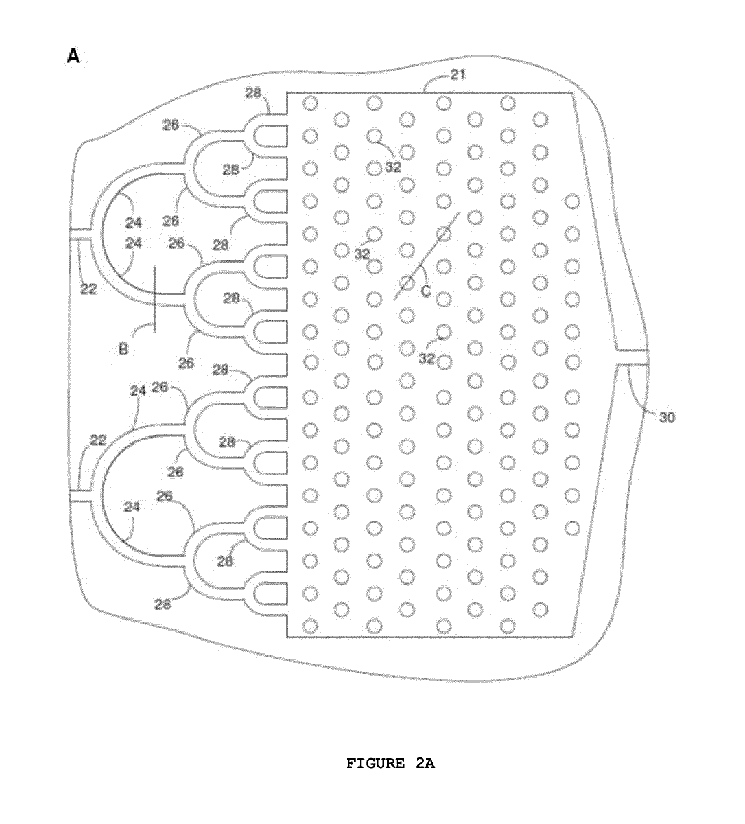

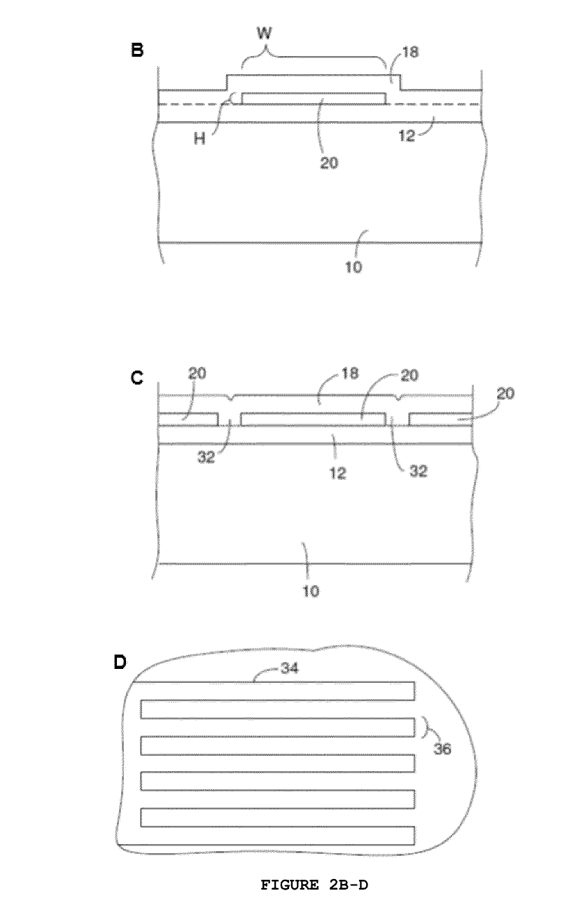

FIGS. 2A-C illustrate a portion of an example of a microfluidic processing device. FIG. 2A is a topview of the microfluidic processing device. FIG. 2B is a cross section of the device shown in FIG. 2A taken along the line labeled B in FIG. 2A. FIG. 2C is a cross section of the device shown in FIG. 2A taken along the line labeled C in FIG. 2A.

The device includes a variety of transport channels and a chamber 21. The transport channels include input channels 22, intermediate channels 24, secondary intermediate channels 26, tertiary intermediate channels 28, and output channels 30. Each input channel 22 intersects two of the intermediate channels 24; each of the intermediate channels 24 intersects two of the secondary intermediate channels 26; and each of the secondary intermediate channels 26 intersects two of the tertiary intermediate channels 28 and so forth. Each of the tertiary intermediate channels 28 is in direct liquid communication with the chamber 21. The chamber 21 is in direct liquid communication with the output channel. During operation of the device, a liquid flows through each of the input channels 22 toward the chamber 21. The liquid flows from the input channel 22 into two intermediate channels 24, then into four secondary input channels 26 and then into the chamber 21.

The chamber 21 includes multiple obstructions 32. The obstructions 32 are arranged such that liquids entering the chamber 21 from different input channels 22 are mixed within the chamber 21. The obstructions 32 can also be designed and used to control the liquid flow rate before entering the next unit/chamber. In addition, the structures can be used assist in evaporation and concentration of a sample or liquid. The branch and post-structures help control the flow-rate automatically (without having pumps and valve), which decrease size and weight of the platform. For instance, the obstructions 32 shown in FIG. 2A are arranged in a two dimensional array. The spacing of the obstructions 32 in the array is such that there is no flow path directly from the secondary transition channel to the output channel. As a result, the liquids must flow around the obstructions 32 in order to reach the output channel. The flow of the liquids around the obstructions 32 causes the liquids to interact and mix.

The liquids that enter the chamber 21 from different input channels 22 can be the same or different. Although the device is shown as mixing liquids from two different input channels 22, the device can include a single input channel 22 or more than two input channels 22. Accordingly, the chamber 21 can provide mixing of components within a single liquid or can provide mixing of two or more liquids. Other uses for the chamber 21 include, but are not limited to, concentrating (e.g., evaporative concentrating), mixing reagents, heating, cell-lysis, DNA extraction, reverse transcription, and dielectrophoresis.

The microfluidic processing device of FIG. 2A through FIG. 2C channel junctions, complex branching structures, and small posts that serve as the obstructions 32. These features have proven difficult to fabricate with other methods; however, the device formation method has proven highly effective at producing these features with the desired dimensions. As a result, the device formation method is suitable for fabrication of microfluidic processing devices such as are disclosed in the context of FIG. 2A through FIG. 2C. For instance, the dashed lines in FIG. 2B and FIG. 2C illustrate the interface between the first containment layer 12 and the second containment layer 18. When using the device formation method to fabricate a microfludic processing device, the sacrificial layer 14 is patterned with the pattern that is desired for the various liquid containment features. For instance, in order to achieve the device of FIG. 2A through FIG. 2C, the sacrificial layer 14 can have the pattern of the transport channels and chamber 21 shown in FIG. 2A. Further, when it is desirable for a channel, chamber, or reservoir in a device constructed according to FIG. 2A through FIG. 2C to include one or more active components such as electrodes, sensors, heating elements or other components, the active component can be positioned at the desired location after formation of the first containment layer 12 and before the sacrificial layer 14 is coated on the device. As a result, the active component will be coated with the sacrificial layer 14 after patterning of the sacrificial layer 14. The removal of the sacrificial layer will expose the active component on the final device. In another embodiment, heating elements and temperature sensors can be provide below the first containment layer 12 to avoid any incompatibility of solution/reagent and such elements.

The device formation method has proven to be effective when fabricating long transport channels such as transport channels with a length greater than one or more inches, or one or more feet, or one or more yards. For example, the method has been used to generate channels of 10 meters in length (see, e.g., Satsanarukkit et al., Transducers, pp. 155-158, 2013, which is incorporated herein by reference). FIG. 2D is a topview of a portion of a microfluidic processing device having a transport channel 34 layout that is suitable for placement of longer transport channels on devices of limited size. The transport channel of FIG. 2D can have a cross section as illustrated in FIG. 2B. Multiple returns 36 are used in order to reduce the space occupied by the transport channel. The number of returns can be increased or decreased as needed to achieve the desired length for the transport channel.

Although FIG. 2B is disclosed as a cross section of a transition channel, the cross section shown in FIG. 2B can represent a cross section of any of the transport channels. As is evident from the line labeled B in FIG. 2A, the cross section of FIG. 2B is across the direction of liquid flow through the transport channel. A longitudinal axis of the transport channel is centrally positioned within the transport channel and is parallel to the direction of liquid flow within the transport channel. Accordingly, the containment structure 16 defined by the first containment layer 12 and the second containment layer 18 surrounds the longitudinal axis of the transport channel.

The transport channel illustrated in FIG. 2B has a width labeled W and a height labeled H. The volume of the one or more liquid and or samples processed by microfluidic processing devices is often less than 1 mL and can be less than 1 μL. Accordingly, in some instances, the width of the transport channel is less than 1,000 μm, 100 μm or 50 μm and/or a height less than 50 μm, 25 μm or 10 μm.

The device formation method is also suitable for fabrication of devices where the first containment layer 12 and/or the second containment layer 18 are separated from the substrate 10. In these instances, the substrate 10 can operate as a mold. For instance, FIG. 3A illustrates the first containment layer 12 formed on a substrate 10 having a non-planar upper surface. The three-dimensional nature of the substrate 10 allows the upper surface to act as a mold. The second containment layer 18 is formed on the first containment layer 12 so as to form a containment gap 20 as disclosed above. A plane can be drawn perpendicular to the substrate 10 and such that the intersection of the plane with the first containment layer 12 and the second containment layer 18 surrounds the containment gap 20. Parylene deposition is a conformal coating (e.g., parylene will also coat any structures such as pillars or obstructions in a channel or chamber).

The first containment layer 12 and the second containment layer 18 of FIG. 3A can be separated from the substrate 10 so as to provide the device of FIG. 3B and FIG. 3C. FIG. 3B is a perspective view of the resulting device. FIG. 3C is a cross section of the device shown in FIG. 3B taken along the plane labeled C in FIG. 3B. Accordingly, FIG. 3D illustrates the intersection of the plane labeled C and the device. The intersection of the plane labeled C and the device surrounds the containment gap 20. FIG. 3D is a cross section of the device shown in FIG. 3B taken along the plane labeled D in FIG. 3B. Accordingly, FIG. 3D illustrates the intersection of the plane labeled D and the device. The intersection of the plane labeled D and the device surrounds the containment gap 20. The plane labeled C and the plane labeled D are perpendicular to each other. As a result the device is configured such that two perpendicular planes can each intersect the device such that the resulting intersection between the containment structure 16 and the plane surrounds the containment gap 20. Suitable methods for separating the first containment layer 12 and/or the second containment layer 18 from the substrate 10 include, but are not limited to, mechanical separation techniques.

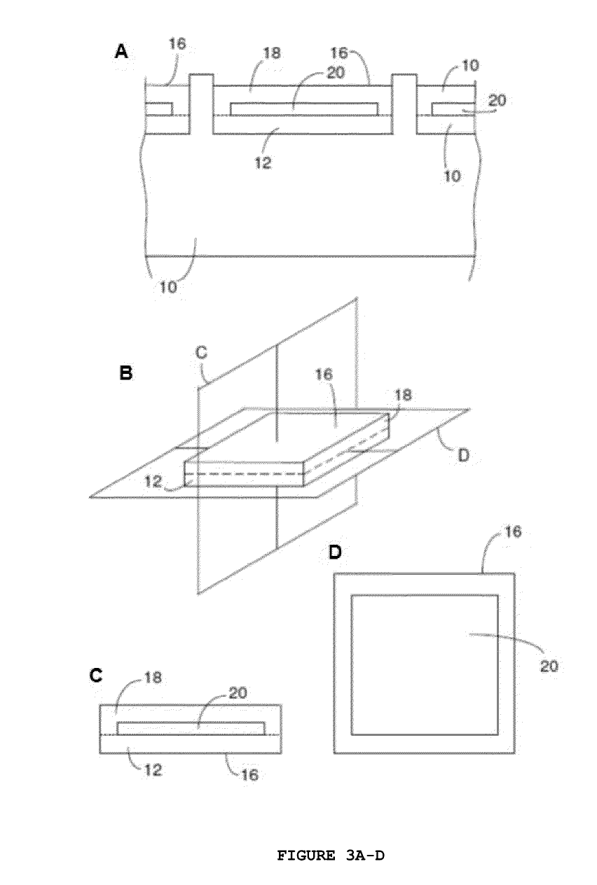

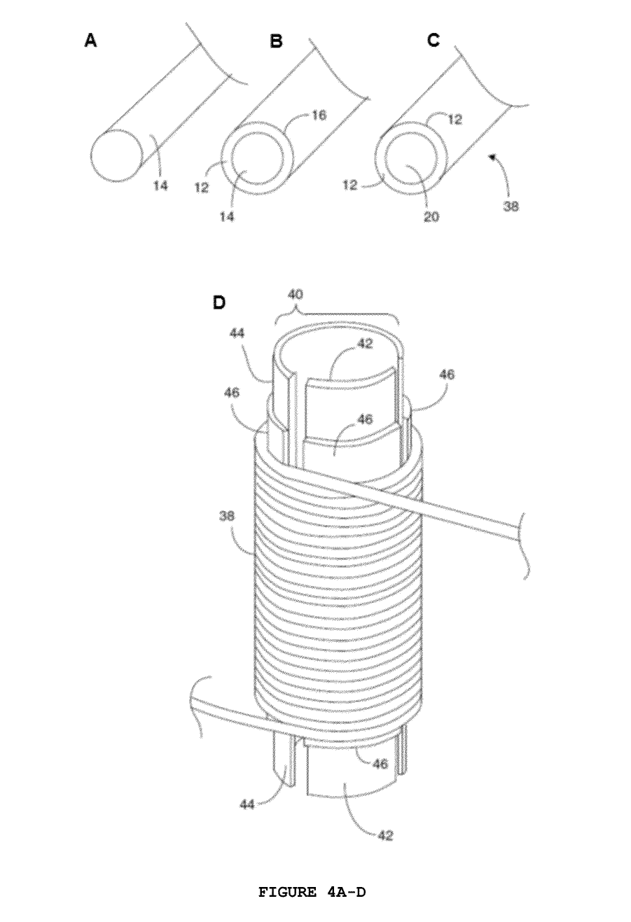

The device formation method can also be performed without a substrate 10. For instance, one or more of the containment layers can be formed on a sacrificial layers 14 so as to form a containment structure 16 that surrounds the containment layer and then the sacrificial layer 14 can be removed from the containment structure 16. FIG. 4A through FIG. 4C illustrate use of this method to form a fluid conduit. FIG. 4A is a perspective view of a rod or wire of the sacrificial layer 14. The first containment layer 12 can be formed on the sacrificial layer 14 of FIG. 4A so as to provide the device precursor of FIG. 4B. Suitable methods for forming the first containment layer 12 on the sacrificial layer 14 include, but are not limited to, coating and deposition. A suitable method for deposition of the first containment layer 12 include, but are not limited to, vapor deposition methods such as Chemical Vapor Deposition (CVD). Suitable methods for coating the first containment layer 12 on the sacrificial layer 14 include, but are not limited to, dip coating. The sacrificial layer 14 can be removed from the device precursor of FIG. 4B so as to generate the device of FIG. 4C. The device includes a containment structure 16 having a surface that defines a containment gap 20. The containment structure 16 includes or consists of at least a portion of the first containment layer 12. The surface of the first containment layer 12 can define the entire containment gap 20. A longitudinal axis of the containment gap 20 is centrally positioned within the containment gap 20 and is parallel to the direction of liquid flow within the containment gap 20. Accordingly, the confinement structure surrounds the longitudinal axis of the containment gap 20. Because the method is suitable for fabrication of devices with small features, the width or diameter of the containment gap 20 can be less than 1,000 μm, 100 μm or 50 μm. The length of the containment gap 20 can be determined by the length of the rod or wire of the sacrificial layer 14 and can be more than 1,000 μm, 10 cm, or 0.5 m.

The device of FIG. 4C can serve as a fluid conduit 38 such as a tube and can be used in a variety of applications. For instance, FIG. 4D is a perspective view of a liquid flow structure that can be fabricated using the fluid conduit 38 of FIG. 4C. The liquid flow structure includes a core 40 having a shape that approximates a cylindrical annulus. The core 40 includes or is defined by a first heater 42 and a second heater 44. An outer surface of the first heater 42 and the second heater 44 each defines a different portion of the perimeter of the core 40. Additionally, the first heater 42 and the second heater 44 are spaced apart from one another by a gap so as to provide a degree of thermal insulation between the first heater and the second heater. Suitable heaters include, but are not limited to, resistive heaters.

A thermally conducting layer 46 can optionally be positioned on the outer surface of first heater 42 and another thermally conducting layer 46 can optionally be positioned on the outer surface of second heater 44. The thermally conducting layers 46 can be configured to evenly distribute heat generated by the underlying heater. Suitable thermally conducting layers 46 include, but are not limited to, metal layers.

The fluid conduit 38 of FIG. 4C is passed around the core 40 of FIG. 4D multiple times so the fluid conduit 38 has multiple coils that each take one complete turn around the core 40. In some instances, the fluid conduit 38 has a helical configuration with each coil being equidistant or substantially equidistant from the center of the core 40. The thermally conducting layers 46 are located between the fluid conduit 38 and the first heater 42 and the other thermally conducting device is between the fluid conduit 38 and the second heater 44. At least a portion of the coils are each positioned over the first heater 42 and the second heater 44 in that a line extending outward from the center of the core 40 passes through a heater and a coil with the heater being between the coil and the center of the core 40.

In some instances, the liquid flow structure can be configured such that at least a portion of the coils are each in direct contact with both the thermally conducting layer 46 over the first heater 42 and the thermally conducting layer 46 over the second heater 44 or are each in direct contact with both the first heater 42 and the second heater 44. Accordingly, heat generated by the first heater 42 is conducted to a medium in the containment gap 20 of the device. Electronics can operate the first heater 42 and the second heater 44 such that the first heater 42 is at a different temperature from the second heater 44. Accordingly, at least a portion of the coils are each constructed such that when a liquid flows through the coil, the liquid is exposed to thermal energy from each of the different heaters.

Accordingly, the liquid flowing through these coils can experiences two different temperatures. Accordingly, the liquid flow structure is suitable for use as a flow-through Polymerase Chain Reaction (PCR) reactor. Each complete turn by fluid conduit 38 around core 40 can represent a PCR thermocycle. Accordingly, the more complete turns that fluid conduit 38 makes around core 40, the more PCR thermocycles. Other applications for the liquid flow structure include, but are not limited to, solid phase extraction (SPE) columns, gas chromatography, and electrospray ionization nozzles.

In a particular embodiment, fluid conduit 38 makes between 25 and 55, between 40 and 52, or between 45 and 50 complete turns around core 40. To facilitate heat transfer, core 40 comprises a 2 cm tall by 1 in wide copper pipe with grooves set into it to produce forty turns by fluid conduit 38. The copper pipe is heated in thermally insulated sections by heaters (managed by PID temperature controllers), and fluid conduit 38 is run through the grooves so it is almost completely surrounded by the uniformly heated copper, ensuring optimal sample heating.

Although the liquid flow structure of FIG. 4D is disclosed as having two heaters, the liquid flow structure can have a single heater or more than two heaters.

In one embodiment, the effluent fluid from port 30 of FIG. 2A can be fluidly connected to a fluid device of FIG. 4D. In various embodiment, the device of FIG. 4D can be used to cycle a temperature through an effluent fluid from port 30. Examples of useful thermocycling processes include PCR reactions, heat denaturing, heat inactivation and the like.

The sacrificial layer can be any general material that can form a tube. For example, with reference to FIG. 4, the sacrificial layer 14 can be a glass tube, wire or the like that can be mechanically withdrawn from the surrounding containment structure 16. In other embodiment, sacrificial layer 14 includes, consists, consists essentially, or is more than 50 wt % of one or more sacrificial polymers. Example sacrificial polymers for the sacrificial layer 14 include, but are not limited to, alternating or periodic copolymers where first repeating units in the backbone of the copolymer include carbon dioxide and second repeating units in the backbone of the copolymer includes an organic groups that are substituted or unsubstituted. Examples of suitable organic groups include, but are not limited to, alkylene oxide. An example of a suitable copolymer is a poly(alkylene carbonates) that can be branched or unbranched and can be fully halogenated, partially halogenated, or unhalogenated. Poly(alkylene carbonates) can have a backbone with repeating units represented by the following Formula I:

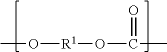

and/or can be represented by the following Formula II:

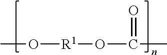

wherein n is greater than or equal to 2, 3, or 4. In Formula I and Formula II, the variable R¹ can represent an alkylene moiety that is branched or unbranched and/or fully halogenated, partially halogenated, or unhalogenated. In some instances, the variable R¹ represents branched or unbranched ethylene.

In some instances, the sacrificial layer 14 includes, consists, consists essentially, or is more than 50 wt % of poly(propylene carbonate).

The first containment layer 12 and/or the second containment layer 18 each includes, consists, consists essentially, or is more than 50 wt % of one or more containment polymers. Suitable containment polymers are polymers or copolymers having a backbone that includes one or more repeating units that include a substituted or unsubstituted aryl group. An example of a suitable containment polymer is represented by the following Formula III:

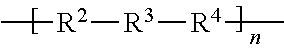

wherein n is greater than or equal to 2, 3, or 4; R² represents an alkylene group that can be branched or unbranched and/or halogenated or unhalogenated; R³ represents an organic moiety that includes or consists of one or more aryl groups that is substituted or unsubstituted and/or halogenated or unhalogenated; and R⁴ represents an alkylene group that can be branched or unbranched and/or halogenated or unhalogenated. In some instances, R² represents the same moiety as R⁴. In another example, R² represents the same moiety as R⁴ and R³ represents a bivalent aryl group that is substituted or unsubstituted and/or halogenated or unhalogenated.

Examples of suitable containment polymers include parylenes. Suitable parylenes can be represented by the following Formula IV:

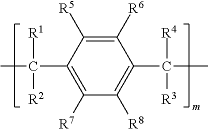

wherein m is greater than or equal to 1, 2, 3, or 4; R¹ represents a hydrogen, halogen, or an organic group; R² represents a hydrogen, halogen, or an organic group; R³ represents a hydrogen, halogen, or an organic group; R⁴ represents a hydrogen, halogen, or an organic group; R⁵ represents a hydrogen, halogen, or an organic group; R⁶ represents a hydrogen, halogen, or an organic group; R⁷ represents a hydrogen, halogen, or an organic group; and R⁸ represents a hydrogen, halogen, or an organic group. When more than one of the variables R¹ through R⁸ represents an organic group, different organic groups can be the same or different. Suitable organic groups for one or more of the variables R¹ through R⁸ include, but are not limited to, linear or cyclic alkyl groups having one, two, three or more features selected from the group consisting of branched, unbranched, substituted, unsubstituted, fully halogenated, partially halogenated, and unhalogenated. In one example, the variable R¹, R², R⁴, and R⁴ are each a hydrogen. In another example, the variable R¹, R², R⁴, and R⁴ are each a hydrogen and at least one or two of the variable selected from the group consisting of R⁵, R⁶, R⁷, and R⁴ is an alkyl group that is unbranched and unsubstituted.

In some instances, the first containment layer 12 and/or the second containment layer 18 each includes, consists, consists essentially, or is more than 50 wt % of a polymer that includes repeating units represented by the following Formula V;

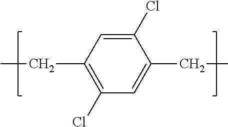

or the polymer represented by the following Formula VI;

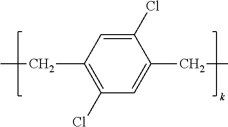

wherein k is greater than or equal to 2, 3, or 4.

In some instances, the device formation method is performed such that the first containment layer 12 and/or the second containment layer 18 each includes, consists, consists essentially, or is more than 50 wt % of the polymer represented by Formula VI and the sacrificial layer includes, consists, consists essentially, or is more than 50 wt % of poly(propylene) carbonate. Experimental results have shown that poly(propylene) carbonate can be thermally decomposed and released from the containment layer at temperatures below 300° C., 275° C., or 250° C. For instance, these materials allow the thermal decomposition to be performed at a temperature of about 240° C.

Although the specification and claims include terms such as first and second, such terms do not indicate sequence or the existence of other components. For instance, a device disclosed, as having a third component does not mean the device necessarily includes a first component and a second component.

Due to the weight, size and power consumption of conventional concentration and preparation devices (e.g., InnovaPrep Concentrating Pipette and InnovaPrep HDL-40) these devices lack portability and are not suitable for on-site sample preparation. By contrast, the parylene based devices disclosed herein are lightweight, of a limited size and have minimal power consumption. Accordingly, the parylene based devices disclosed herein are highly portable and ideally suited for on-site sample testing. In a particular embodiment, the disclosure provides for a parylene based sample preparation and/or concentration device that utilizes dielectrophoresis, transverse isolectric focusing, ultrasonic trapping, chromatography, centrifugation, and/or evaporation.

In a certain embodiment, the disclosure provides for a parylene based preparation and/or concentration device which utilizes dielectrophoresis. In a further embodiment, the parylene based dielectrophoresis device is portable and can be used on-site to test/analyse samples. Dielectrophoresis (or DEP) is a phenomenon in which a force is exerted on a dielectric particle when it is subjected to a non-uniform electric field. This force does not require the particle to be charged. All particles exhibit dielectrophoresis activity in the presence of electric fields. However, the strength of the force depends strongly on the medium and particles' electrical properties, on the particles' shape and size, as well as on the frequency of the electric field. Consequently, fields of a particular frequency can manipulate particles with great selectivity. This has allowed, for example, the separation of cells or the orientation and manipulation of nanoparticles and nanowires. Furthermore, a study of the change in DEP force as a function of frequency can allow the electrical (or electrophysiological in the case of cells) properties of the particle to be elucidated. Studies have shown that based upon the dimension and orientation of deflector structures, particles can separated by size so as to allow for the collection of fractions with small sample volumes. The effectiveness of the dielectrophoresis deflection structures is influenced by the channel height, particle size, buffer composition, electric field, strength and frequency of the dielectric force. Dielectrophoresis can therefore be envisioned to separate and concentrate microorganisms and biomolecules in addition to more conventional applications. Moreover, dielectrophoresis has been shown as an effective method to separate human blood cells from plasma and other blood components. In a certain embodiment, the disclosure provides for a portable parylene based dielectrophorectic preparation and/or concentration device that can be used to separate and concentrate microorganisms and/or biomolecules from samples collected on-site.

In another embodiment, the disclosure provides for a parylene based preparation and/or concentration device utilizing transverse isoelectric focusing. In a further embodiment, the parylene based transverse isoelectric focusing device is portable and can be used on-site to test/analyse samples. There are several advantages to applying isoelectric focusing techniques to preparation and/or concentration devices. One is that the small distance between the electrodes (i.e., the microchannel width) allows a high field to be generated at low potentials between the electrodes. This high field causes rapid movement across a large fraction of the channel width. At low Reynolds numbers it is then possible to route the particles in adjacent streamlines in the channel and into separate outflow streams, thereby segregating the particles by their isoelectric points. The pH gradient across the width of the channel can be established by any of several means. For example, it is possible to bring into the entrance port of the microchannel multiple fluid streams at different pH values, with or without buffering. To the extent that the pH values do not become uniform across the channel before the particle separation is achieved, this approach is acceptable. Voltages of less than about 5 V, preferably less than about 2.5 V and more preferably less than about 1.2-1.3 V between two gold electrodes in a microchannel, that effective changes in pH are observed, but no evolution of bubbles occurs in either static or flowing systems. The use of “nongassing” electrode materials such as palladium or platinum allows the use of higher voltages. The generation of acid at the anode and base at the cathode leads to the generation of a pH gradient across the channel in either a static or flow system. The steepness of the gradient and its central pH value are determined by the chemistry at the electrodes, the buffering capacity and chemical composition of the solution between the electrodes, and the potential across the electrodes. By modifying the voltage or nature of the carrier stream, it is possible to adjust the device to be maximally sensitive to certain ranges of isoelectric point thereby enhancing the resolution of a given separation process. The parylene based transverse isoelectric focusing devices used herein utilize a stable pH gradient across a pressure-driven fluid flow in a microchannel. Both proteins and bacteria are shown to align themselves in zones of specific pH corresponding to their isoelectric point. In a certain embodiment, the disclosure provides for a portable parylene based transverse isoelectric focusing preparation and/or concentration device that can be used to separate and concentrate microorganisms and/or biomolecules from samples collected on-site.

In a particular embodiment, the disclosure provides for a parylene based preparation and/or concentration device using ultrasonic trapping. In a further embodiment, the parylene based ultrasonic trapping device is portable and can be used on-site to test/analyse samples. Ultrasonic manipulation has emerged as a simple and powerful tool for trapping, aggregation, and separation of cells. During the last decade, an increasing amount of applications in the microscale format has been demonstrated, of which the most important is acoustophoresis (continuous acoustic cell or particle separation). Traditionally, the technology has proven to be suitable for treatment of high-density cell and particle suspensions, where large cell and particle numbers are handled simultaneously. However, ultrasound can be combined with microfluidics and microplates for particle and cell manipulation approaching the single-cell level. Based upon the cell handling methods, individual cells in microdevices based on multifrequency ultrasonic actuation can be selectively trapped and concentrated. Size-selective separation of microspheres in small-diameter capillaries can be ultrasonically trapped by using longitudinal hemispherical standing-waves. The ultrasonic trap can be further modified to allow for ultra-sensitive detection of trace amounts of proteins and other macromolecules containing two antigenic sites, by binding the target molecule with high specificity to label-coated latex spheres. In a certain embodiment, the disclosure provides for a portable parylene based ultrasonic trapping preparation and/or concentration device that can be used to separate and concentrate microorganisms and/or biomolecules from samples collected on-site.

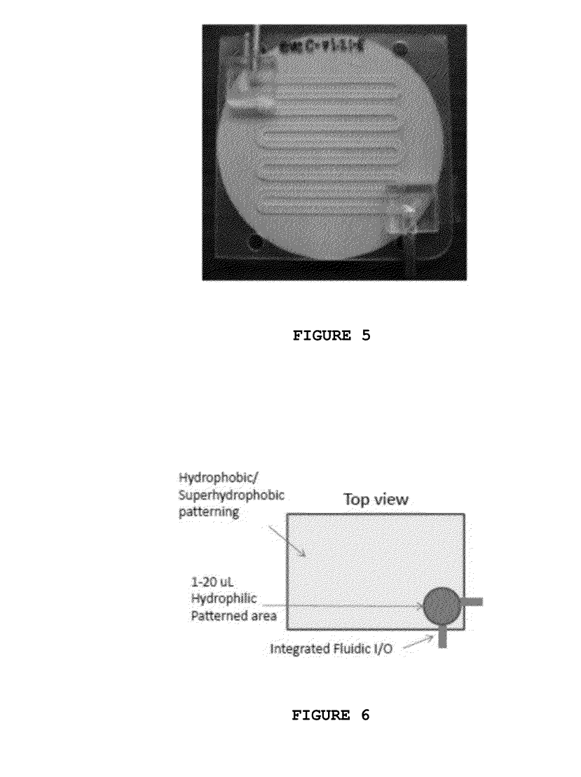

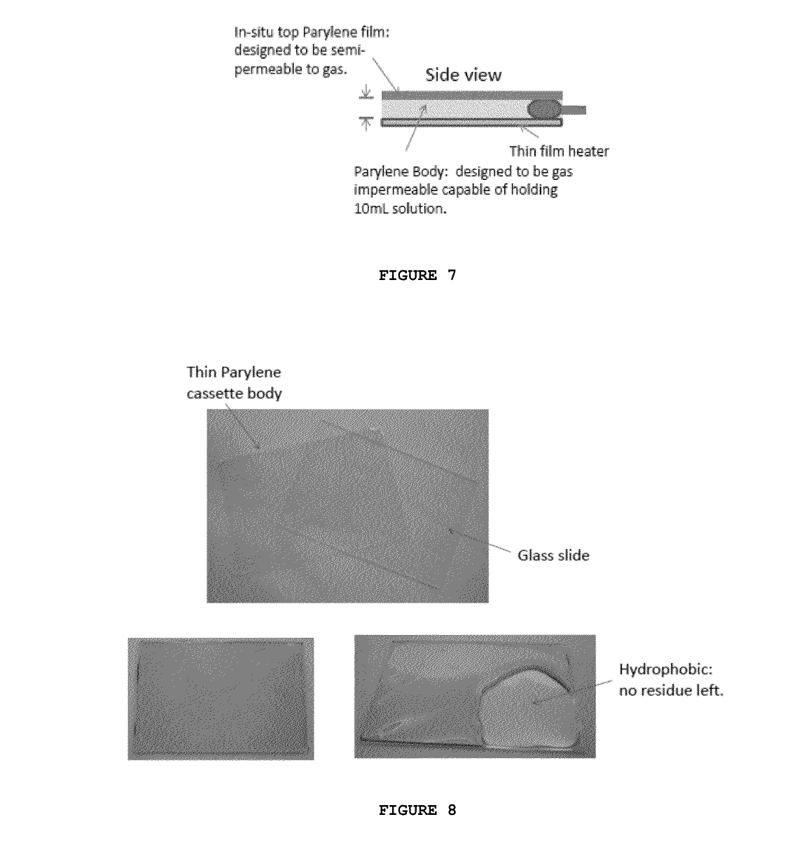

In a particular embodiment, the disclosure provides for a parylene based preparation and/or concentration device that utilizes evaporation. In a further embodiment, the parylene based evaporative device is portable and can be used on-site to test/analyse samples. The parylene based preparation and/or concentration device utilizes isothermal evaporation, which is physically different than the more commonly experienced phenomena of bulk boiling. While bulk boiling requires heating the liquid above its boiling point until a rapid phase change to gaseous state can occur anywhere throughout the liquid volume, isothermal evaporation is a gentler surface evaporation process driven by the concentration gradient of water vapor. In a particular embodiment, the parylene based evaporative preparation and/or concentration device disclosed herein is comprised of one or more of the following components: a serpentine liquid channel, a parallel air channel, a porous (e.g., 1 μm pores) laminated Teflon hydrophobic membrane (e.g., 175 μm thick), and/or pressure sensitive adhesive (e.g., see FIG. 5). The air channel directly overlays the fluid channel thus increasing structural robustness, with rigid walls that hold the hydrophobic membrane in place while guiding the air flow directly over the active evaporator surfaces. In a further embodiment, the parylene based evaporative preparation and/or concentration device is further comprised of a cassette comprising a first layer which seals the bottom of the card while providing liquid connection ports, a liquid channel that sits on top of the first Mylar layer, a porous hydrophobic membrane with 1 μm pores that forms a shared porous wall between the liquid and air channels, an acrylic layer that forms the air channel, and a second Mylar layer that seals the top of the card while providing air connection points; wherein one or more of the layers and/or membranes comprise Parylene. Parylene technology allows for easy pattering: the normal film is hydrophobic (contact angle) ˜70°, while oxygen plasma pattering allows for a film that is hydrophilic (contact angle) ˜4-10° (e.g., see FIG. 6). The sample is drawn and concentrated in the hydrophilic patterned area. Parlyene technology further allows functionally based upon the film's thickness: thin film<10 μm is semi-permeable to gas); and thick film>40 μm is gas impermeable (e.g., see FIG. 7). Accordingly, the cassette can comprise multiple parylene layers to increase solution surface/volume ratio and to optimize the parylene device's height to achieve good mechanical stability with a high evaporation rate. By integrating parylene, the evaporative concentrating device's weight and size can be reduced while power consumption is also reduced.

On-chip PCR technology is particularly useful for single cell or viral analysis. This technology is capable of fast and easy cell loading and precise cell alignment, two steps in single cell analysis. The free-standing on-chip heater and sensor reduces the system's thermal mass and increases the heating and cooling rates. Researchers have been investigating many materials for on-chip PCR chambers. Among inorganic materials, opaque silicon inhibits PCR amplification and bars optical detection. Though transparent, glass possibly impedes PCR reactions. Besides the less-than-satisfactory inorganic materials, researchers have looked to polymers and many have examined PDMS. However PDMS is not ideal, either. PDMS is porous and permeable, and it causes bubbles and loss of PCR samples during PCR reactions. Provided herein is the use of parylene (e.g., parylene-C or parylene-D) as the material for PCR reaction chambers and channels. Parylene is biocompatible and chemically inert. When thicker than fifteen angstroms, parylene is pin-hole free. Pin-hole free parylene may reduce PCR reagent evaporation and bubble formation. Furthermore, parylene technology allows easy integration of other components: sample loaders, cell capturing filters, waste disposal parts, and DNA detectors. A parylene based PCR system may have less thermal mass than a PDMS based system.

The disclosure provides for a PCR reaction system based on parylene (e.g., parylene-C or parylene-D) which has not been surface treated. For on-chip PCR amplification detection, a fluorescence-based detection technique. This technique includes a TaqMan® probe, which consists of a fluorophore, a quencher and a 20-40 bp ssDNA. In practice, the probe first binds to the amplified target DNA fragment. After DNA polymerization, the polymerase cleaves the 5′ end of the probe, releasing the fluorophore. The released, unquenched fluorophore emits fluorescent light. Due to the probe's specific binding capability, the fluorescence intensity is proportional to the number of the amplified target DNA fragments.

The disclosure provides fabrication methods to produce the parylene based devices disclosed herein, including methods to produce parylene based PCR chip devices. For example, parylene based PCR chip devices can be fabricated by etching silicon, and depositing layers of parylene. In a particular embodiment, parylene based PCR chip devices can be produced by the one or more methods presented herein in the Examples section.

Although qPCR-PMA assay was developed for lab-scale platforms, the parylene based on-chip PCR device disclosed herein allows for the use of the qPCR-PMA assay in a microfluidic format. In a particular embodiment, the disclosure provides for an on-chip PCR device which incorporates a free-standing parylene channel with an integrated platinum heater for on-chip temperature cycling. The PCR on-chip reduces the reagent amount from tens of uL (as required by convention qPCRs) to 550 nL. The on-chip PCR has a higher thermal efficiency than conventional PCR because of its smaller thermal capacity and good heat transfer. The demonstrated chip's free-standing channel structure reduces the thermal capacitance to 3.25 mJ/° C. and shortens the duration of PCR cycles with a thermal time constant of 3 seconds. The transparent parylene channel invisible light range enables direct optical detection. The impermeable parylene channel also prevents solution evaporation. It is shown that the pin-hole free, chemically and biologically inert parylene allows efficient PCR amplification and no additional surface treatment is required.

Bubbling inside the PCR chamber caused by the high denaturation temperature step, evaporation or generated during sample loading can deleteriously effect the PCR reaction. The bubbles create an insulating area which leads to nonuniform heat distribution across the PCR chamber. The small bubbles quickly expand during higher temperature operation and push PCR reagents away from the heating zone, and affect the PCR efficiency. In a certain embodiment, the parylene based PCR on-chip can be modified by one more mechanisms to prevent bubble formation, including clamp packaging.

In a particular embodiment, the disclosure provides for parylene devices that are solar powered and incorporate a solar tracker. For example, the parylene devices can harness sunlight and use a Fresnel lens as heating sources, leading to devices that, in comparison to conventional analytical devices, are greatly reduced in size and weight, and are completely portable. The solar tracker is very simple compared to most 2D solar trackers, which involve expensive microchips or GPS systems. This design uses only photovoltaic cells and motors to track, enabling low cost. The unit is small and portable, and with the microfluidic system it allows us to test samples on site and off the grid. The tracker has 2V photovoltaic panels and 1V motors along with a larger array to power the DNA amplification equipment (9.5″×15″). The motor controlling horizontal motion is attached underneath the base (less than 10″ in diameter), and the height of the device is less than 20″. The second (vertical) axis of motion is achieved by mounting one quarter of a wheel under a motor with a rubber-bound wheel on the shaft. The large array is attached to this wheel, and the tracker is mounted above this array. When balanced, the spinning motor turns the wheel and thus changes the vertical angle of the array. Each solar panel generates 1.4 W of power. The temperature controllers can operate at 1.2 W, so one panel for each of the two temperature controllers can be used. The heaters require 2.5 W of power each, so 2 panels can be used for each heater.

The disclosure further provides for a parylene based microbial monitoring system capable of detecting live bacterial cells from the effluent of a waste water treatment unit. Current microbial monitoring is cultivation-based. It is often labor-intensive and time-consuming to estimate total viable microbial burdens in a quantitative fashion. Since ˜99% of the microbial communities are yet to be cultivated in the laboratory, developing a microbial monitoring system is paramount in accounting most of the microbes present in target samples. Although individual modules are available to collect, concentrate, process, and detect microbes from environmental samples including a simplified digital PCR assay for easy quantitative analysis, an integrated microbial monitoring system is not currently available. The parylene based microbial monitoring system disclosed herein is based on a Micro-Electro-Mechanical System (MEMS) that can be used in conjugation with solar toilets, such as those exemplified in PCT/2013/063790, the disclosure of which is incorporated herein by reference in its entirety. The parylene based microbial monitoring system of the disclosure is a fully integrated system that provides reliable microbial monitoring and is fully portable. The parylene based microbial monitoring system can be used in any place around the world including the developing countries where an integrated and easy-to-use microbial monitoring system is needed. The parylene based microbial monitoring system is capable of testing onsite for pathogenic bacteria, polioviruses and helminthes eggs. Moreover, the parylene based microbial monitoring system can be used in conjunction with solar toilets (e.g., PCT/2013/063790) or with standard toilets.

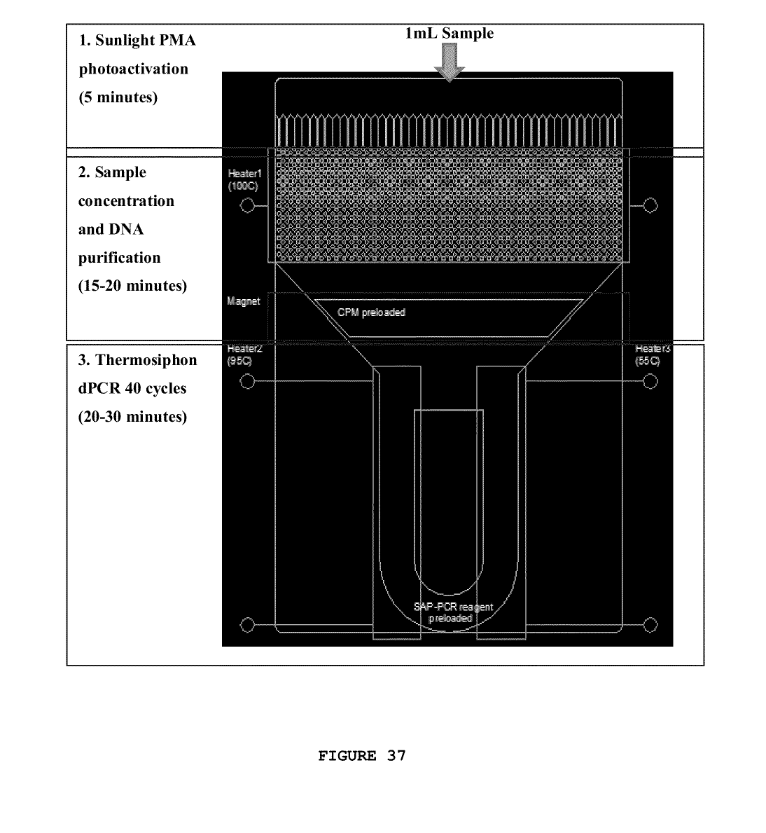

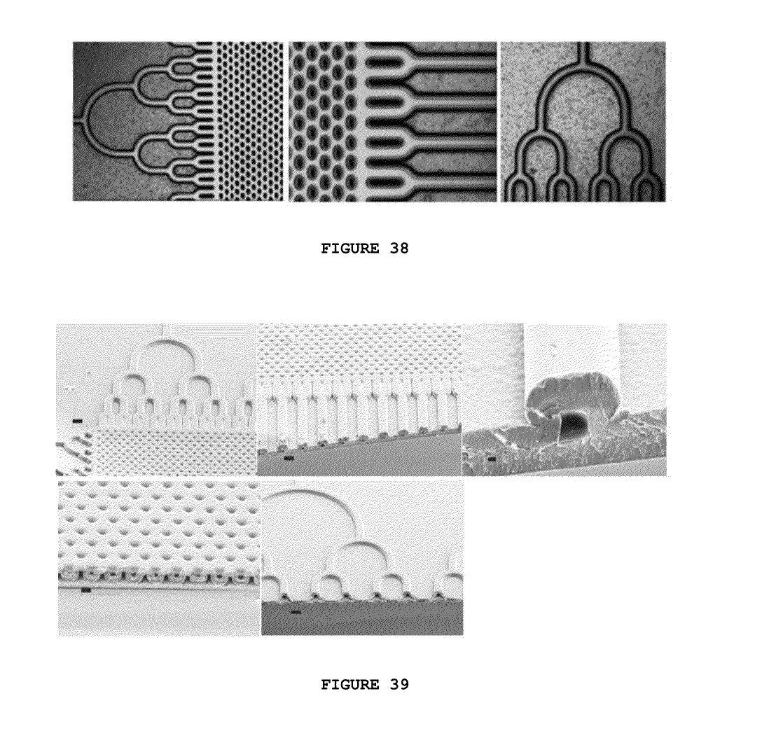

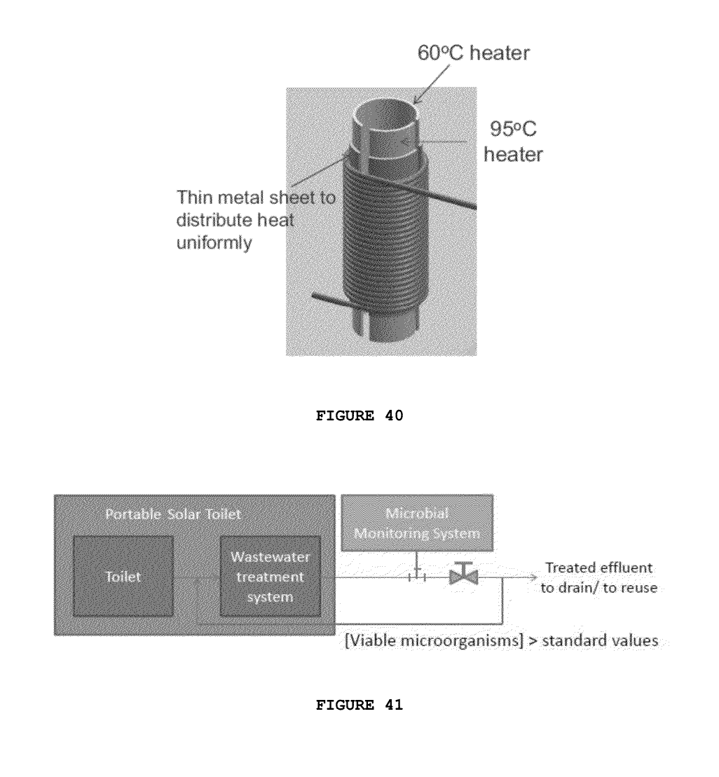

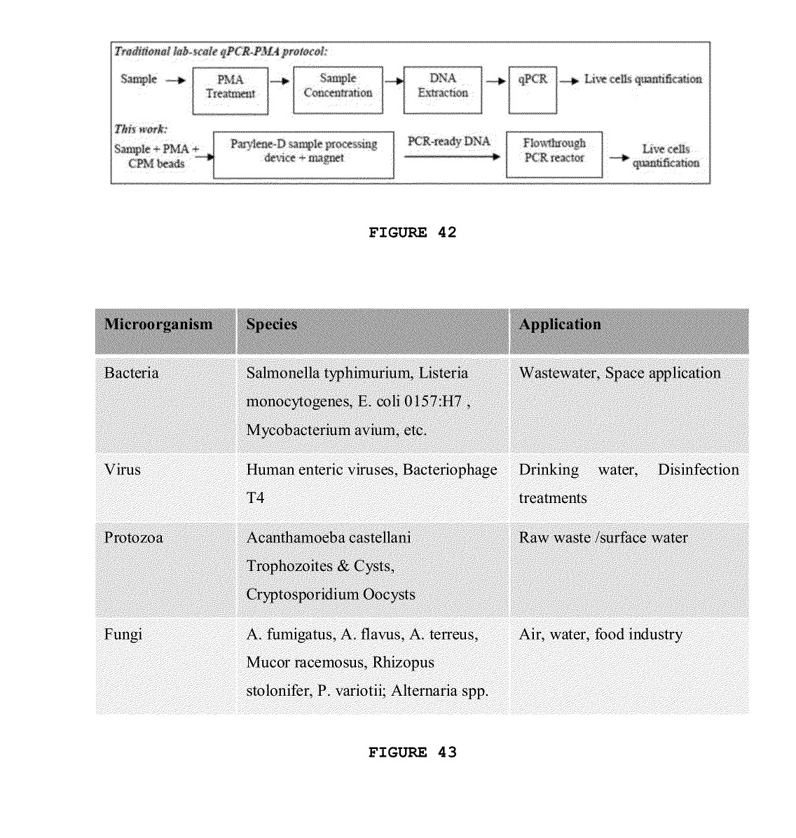

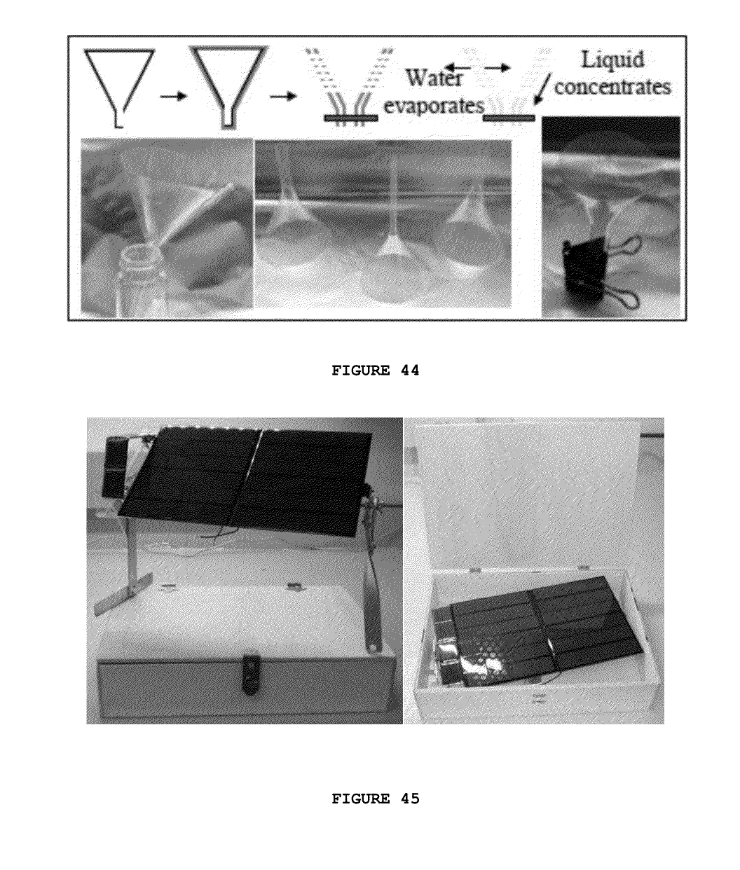

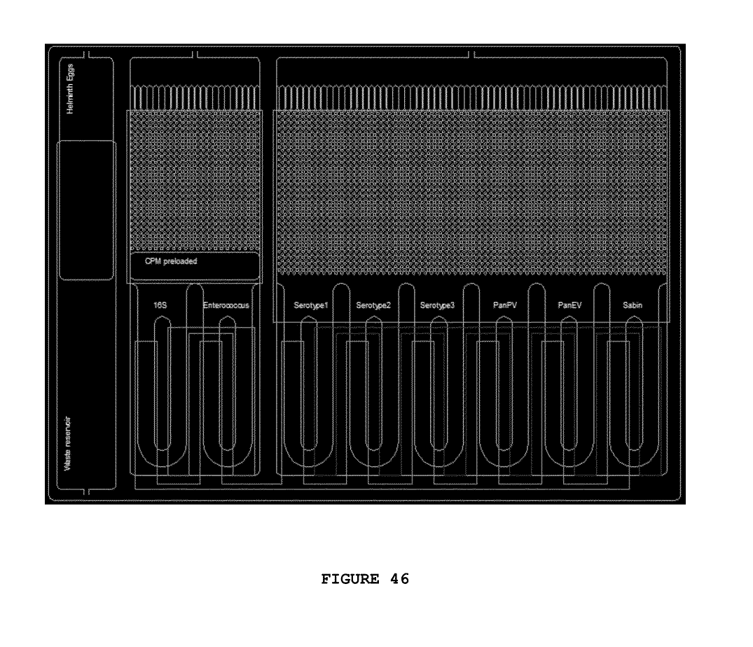

In a further embodiment, the microbial monitoring system disclosed herein comprises a 16s rRNA qPCR-PMA microfluidic assay. In yet a further embodiment, the microbial monitoring system comprises an “all in one” parylene (e.g., see FIGS. 37 and 46) on-chip device that is an integrated microfluidic system capable of performing sample collection, sample concentration, PMA photoactivation, DNA extraction, and qPCR. In another embodiment, the microbial monitoring system comprises a solar-powered unit with automatic solar-tracking. The microbial monitoring system of the disclosure is portable, easy to use and can be used in conjunction with a solar toilet (e.g., PCT/2013/063790). In a particular embodiment, the parylene based microbial monitoring system disclosed herein comprises a parylene based solar powered PCR on-chip device that is capable of differentiating between live and dead cells. The parylene based microbial monitoring system of the disclosure therefore provides a complete process for viable cell quantification.

Current on-chip PCR technologies require microdroplet generators, micromanipulation systems, or micropatterning. This results in complicated device fabrication. The disclosure provides for the use of bioreactors that improve the amplification results of the parylene based PCR on-chip devices disclosed herein and eliminate the need for droplet generators. In a particular embodiment, the bioreactors comprise polymers. Several polymers have been tested and the results showed compatibility with PCR, e.g. agarose, polyacrylamide. These polymers are generally heated above their melting points during droplet reagent encapsulation. Such heating requires an extra microheater and temperature controller. In addition, systems using these polymers require on-chip droplet generators or micropatterning to form in-situ PCR reaction chambers, etc. In yet a further embodiment the bioreactor is super absorbent polymer (SAP). SAP has a swelling capacity for easy droplet encapsulation and mixing. No additional mixing tools, such as strong electric field, are required. Platforms using SAP are simpler. In addition, SAP's swelling property decreases reagent diffusion time during encapsulation into a few minutes (comparing to 30 minutes). SAP also eliminates the general problems brought by current droplet generators, such as unstable droplet formation during the initial filling of microfluidic devices as a result of constantly changing backpressure; droplet instability due to high surface per volume ratio. By using SAP as digital PCR bioreactors, positive and reproducible amplifications were observed. The detection limit down to one-copy of 18S rRNA per SAP droplet was achieved. The results show that the parlyene devices comprising SAP bioreactors do not need an on-chip droplet generator and can further reduce the device's weight, size, and system complexity.

In a particular embodiment, SAP with PCR reagent will be preloaded in to chip so as to (1) help draw purified DNA from the previous unit to mix with the PCR reagent; and (2) to enable small and lightweight devices that use limited power and still provide digital and absolute PCR readings.

The following examples are intended to illustrate but not limit the disclosure. While they are typical of those that might be used, other procedures known to those skilled in the art may alternatively be used.

### EXAMPLES

### Parylene Based Evaporative Concentrator Device

A free-standing Parylene based evaporative concentrator device was developed to concentrate 10 mL of a bacterial solution to 1-20 μLs. PCR-ready DNA can then be extracted in situ from the concentrated bacterial solution. The Parylene based evaporative concentrator device is portable and a field-deployable system, that is less than 500 cm³ in size, less than 0.5 kg in weight, and/or uses less than 5 W of power.

Sample Procedure:

(1) 10 mL of a bacterial solution is loaded in the in the Parylene based concentrator device.
(2) Concentrating the solution to between 1 to 20 μL using evaporation.
(3) Perform DNA extraction using a prepGEM protocol.
(4) Inject 80 μL of the extracted DNA into a PCR device. The efficiency of the Parylene based concentrating device can be determined using benchtop qPCR. The concentration step and DNA extraction step can be optimized by varying the time and/or temperature.

Fabrication of Parylene-C Based on-Chip for PCR.

Parylene-C is the most commonly used among the parylene polymers in microfluidics due to its high mechanical strength, and fast deposition rate. Parylene-C has an USP class VI biocompatible rating. A chemical vapor deposition technique which operates at room temperature can be used to deposit parylene-C on a substrate. The deposition first starts from dimer powder (Specialty Coating Systems) vaporizing. Then the sublimed parylene vapor is pyrolized in the pyrolysis tube at 680° C. The obtained monomers next enter the deposition chamber and are polymerized on the surface of the substrate.

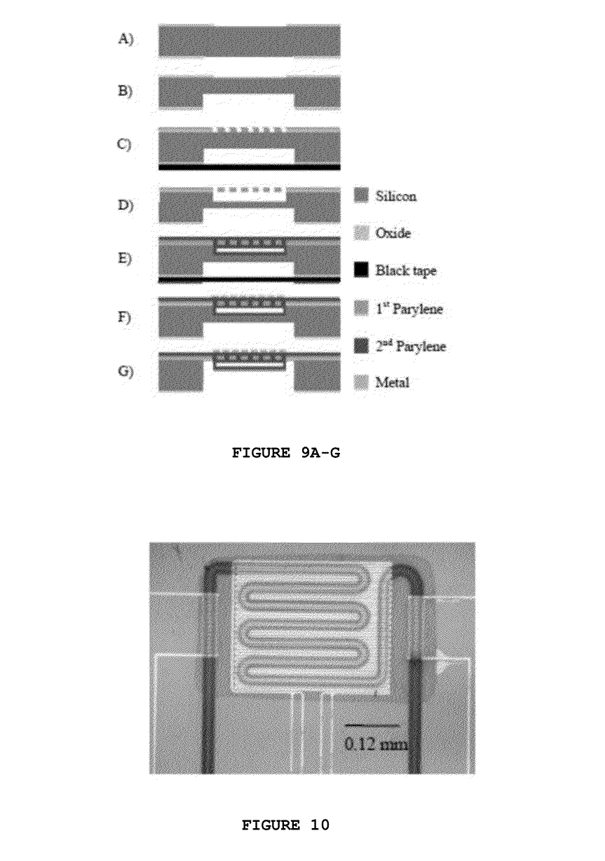

As shown in FIG. 9A-G, chip frabrication started with DRIE etching of silicon on the back of an oxide wafer. Next, a first layer of parylene was deposited and patterned on the silicon. Next, the front side silicon was etched with DRIE and XeF₂. A second layer of parylene was deposited to form a channel. For the resistive heating element, a 2000 Å platinum layer was deposited on the second layer of parylene and patterned using a lift off process. Then the free-standing channel was made by etching the backside of silicon wafer with DRIE and XeF₂. FIG. 10 show the finished PCR chip and the final testing assembly. The parylene channel had an approximate total volume of 550 nl. The platinum heater had a resistance of 2.9 kOhms at room temperature. A CNC-machined acrylic jig then coupled the PCR chip to the loading microfluidic components.

Testing the Heating Dynamics of the Parylene-C Based on-Chip for PCR.

To measure the heating time constant, a pulse of input power was applied. The time when the chip temperature reached 63.2% of its steady state temperature was determined. FIG. 12 shows the input power and the chip temperature profile. The chip's heating time constant was determined to be 3 seconds. To measure the cooling time constant, the chip was first heated to a certain temperature. Once the chip reached the steady state, the applied power was turned off. The time when the temperature reached at 36.8% of the steady state temperature was measured and found to be around 3 seconds.

Temperature Coefficient of Resistance Eq. 1 shows the relation between resistance (R) and temperature (T):

$$\frac{R ( T ) - R ( {T}_{0} )}{R ( {T}_{0} )} = α ( T - {T}_{0} ) \qquad ( 1 )$$

where T₀ is the reference temperature, and α is the temperature coefficient of resistance.

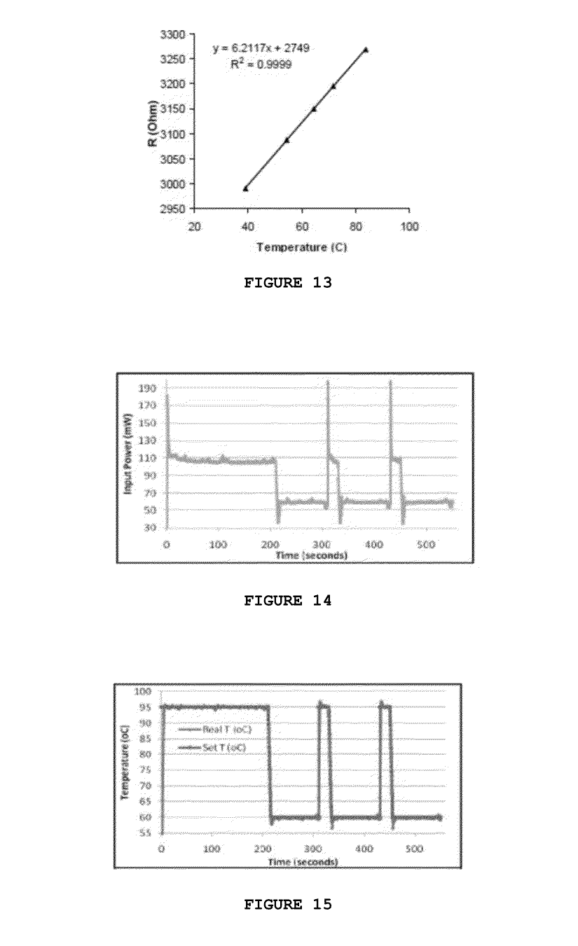

To obtain the TCR, the sensor's resistances were measured at different temperatures, all of which are within the PCR's operational range. The resistance and temperature are plotted in FIG. 13. The sensor's TCR is 2.0×10⁻³/° C.

PCR Reaction Conditions for Testing Parylene-C Based on-Chip for PCR.

The PCR solution consists of 1× Quanta PerfeCTa™ MultiPlex qPCR SuperMix (Quanta Biosciences); 200 nM of forward primer 5′-TGGAGAGGCTATTCGGCTATGACTG-3; 200 nM of reverse primer 5′-ATACTTTCTCGGCAGGAGCAAGGTG-3′; 200 nM of probe 5′-FAM-TAGCAGCCAGTCCCTICCCGCTICAGTGA-BHQ-3′(IDT); 1×ROX; and 6 and 90 pg of high copy plasmid bearing the ColE1 origin of replication and the kanamycin resistance gene pZS25O1+11-YFP. The amplicon fragment is 294 bp.

Comparing the Performance of a Parylene Based PCR on-Chip to a Conventional PCR Thermocycler:

PCR experiments were first performed with a standard thermal cycler and the results were evaluated by gel electrophoresis. The samples were compared using standard polypropylene tubes and parylene-C coated (15 μm) polypropylene tubes. In addition, the minimum volume of PCR reagent needed was determined in order to compare the effects of parylene channels and parylene-coated tube with similar SA/V ratios. Secondly, the PCR reaction was verified with a standard qPCR machine (Stratagene Mx3000). The initial template copies varied from 10 to 10⁷ copies in tenfold increments. The total volume was limited to 20 μL per tube due to the machine's specifications.

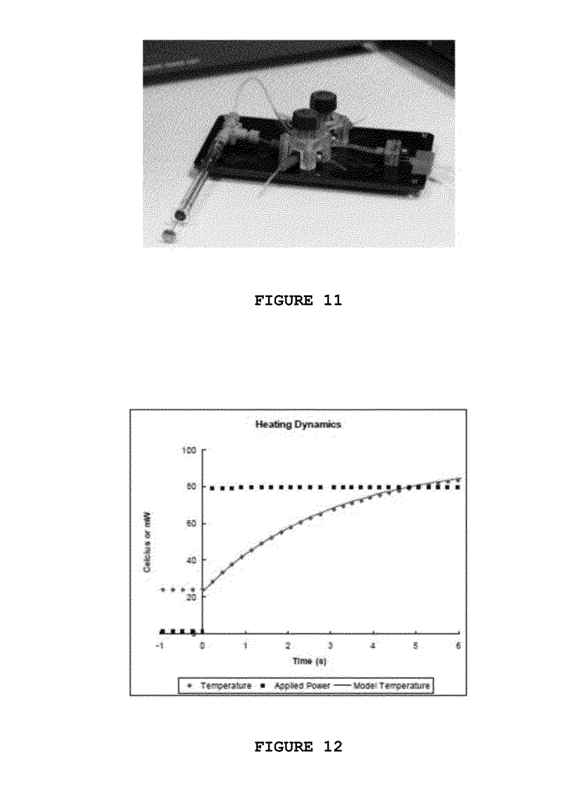

Then, we conducted the on-chip PCR reaction. We first cleaned the parylene channel with DNA decontamination solution (Ambion) and rinsed with DEPC-treated and sterile filtered water (Sigma Aldrich). We manually injected the fluids with a micro syringe (Hamilton), as shown in FIG. 11. Since loading the on-chip does not require a bulky external pumping system, it is feasible for the on-chip to be a portable device. Then the device was filled with the PCR solution as described above. Approximately 550 nl of PCR mixture was injected. For thermal cycling, the on-chip platinum resistor was used as both the heater and temperature sensor. The voltage was supplied from Universal Source (HP 3245A) to the chip and the current was measured with a precision multimeter (Agilent 34401A). The close-loop temperature control for PCR thermal cycling was done with a LabView PID feedback control program. The PCR thermal cycling started with 95° C. for 3 minutes, followed by 50 cycles of 95° C. for 15 seconds (denaturation) and 60° C. for 90 seconds (annealing/extension) respectively. FIG. 14 and FIG. 15 show the first 3 cycles of input power and temperature profiles.

To measure fluorescence, fluorescent images were taken after each thermal cycle using a Nikon Eclipse E800 fluorescence microscope. The E800 microscope has a Nikon super high pressure mercury lamp power supply (Nikon Inc.), and an integrated CCD camera. The fluorescence picture was then analyzed with image processing software, Image J (National Institutes of Health). To reduce the noise from fluctuation of light source and autofluorescence of the chip during the measurement, the obtained fluorescence intensity was normalized against the parylene background on the base of the chip.

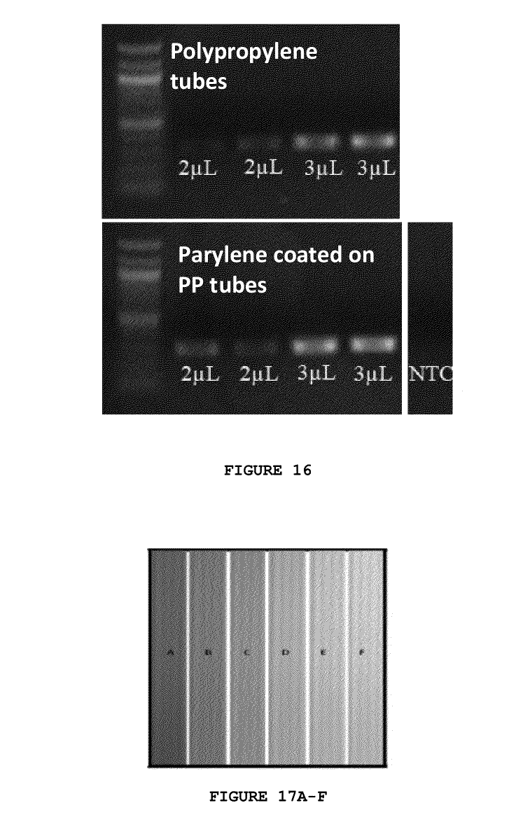

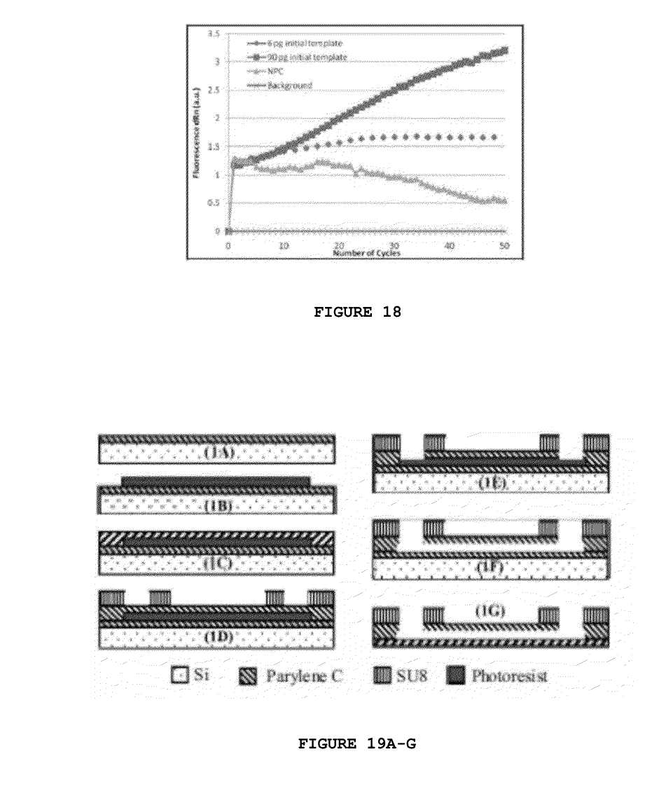

FIG. 16 shows the gel electrophoresis images of the PCR experiments using a standard thermal cycler. In FIG. 16, the amplicon fragments of 294 bp were shown with the 100 bp DNA ladder on the left. The minimum volume for distinguishable bands was 2 μL. No primer-dimer was observed. Also, the parylene coated tubes gave good amplification results. The notemplate-control (NTC) tube shows no amplification band. For the on-chip PCR results, FIG. 17A-F shows the channel fluorescence pictures of 90 pg initial template after the thermal cycles 0^{th}, 10^{th}, 20^{th}, 30^{th}, 40^{th} and 50^{th} respectively. The intensity successfully increases over the cycles. FIG. 18 shows the comparison of amplification plots of fluorescence (dRn) of 6 and 90 pg initial templates, and the no primer control (NPC). These results show that the templates were significantly amplified within the first few PCR cycles. In addition, the curves clearly show the differences of different initial template amounts respectively. This device can differentiate different starting template quantities.

Fabrication of a Freestanding and Flexible Parylene-C Based PCR on-Chip Using Photoresist as a Sacrificial Layer.

This fabrication method provides for the production of a free-standing and flexible parylene PCR device, which is detached from a rigid substrate so no more micromachining of the substrate is needed. As shown in FIG. 19(A-G), the free-standing micro channels have two layers of 10-micron thick parylene and at the inlet and outlet ports, a SU-8 50 (Micro Chem. Corp.) protection layer. Device fabrication starts with depositing a 10-micron parylene-C layer on a Si wafer. Then a 36-micron sacrificial AZ 9260 photoresist layer was deposited and patterned so as to form the microchannel. Before depositing another 10-micron parylene-C layer, the wafer was hard-baked at 120° C. for 8 hours to completely remove the solvent. Then, SU-8 50 was spin coated and patterned to form a protective layer at the inlet and outlet ports. Next, the inlet and outlet ports were opened via laser ablation. The sacrificial layers were then released in room temperature isopropyl alcohol and acetone for around one week. The releasing time could be shortened to 2.5 days by increasing the temperature of IPA and acetone to 40° C. After releasing the photoresist, the micro channel film was peeled off the Si substrate. To improve the adhesion between the two parylene layers, the microchannel film was annealed in vacuum at 200° C. for 2 days. The fabricated micro channel film contains two microchannels, each of which is 100 micron wide. The free-standing microheater sensor was fabricated by depositing 20 nm Ti/200 nm Pt on 10-micron parylene-C using ebeam and a lift-off process. The metal film was peeled off the Si substrate before operation.

Sealing Mechanism to Prevent Bubbling in a Flexible Parylene Based PCR on-Line Chip.

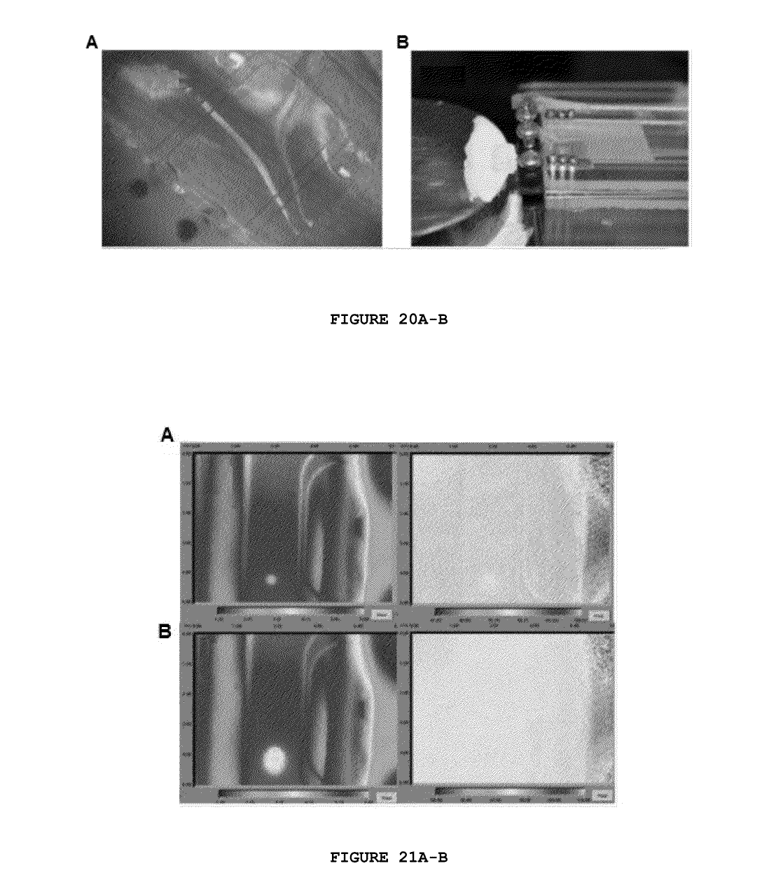

A simple but effective sealing mechanism to prevent bubbling in the parylene PCR microchannels is accomplished by clamping the microchannels with two hard material strips and tightening with a silicone rubber sheet in between (e.g., see FIG. 20B). This clamping mechanism is possible because of the flexibility of the parylene device and it saves complicated, time-consuming in-channel valve fabrication processes and achieves satisfactory sealing performance. The simple sealing mechanism provides almost zero dead volumes and is compatible with existing PCR protocols. Moreover, the sealing mechanism is dispensable and reusable. Due to aspect of the parylene being pin hole free, the sealing mechanism is not contaminated by use.

For the sealing testing, first, diluted food color was loaded into the microchannels. The micro channel film was heated with a digital hotplate (Dataplate Cole Parmer). A film temperature sensor was placed on an aluminum chuck and glued by thermal grease (Omegatherm 201) for good thermal contact. The temperature sensor was calibrated with a thermocouple and temperature tags. The sealed microchannels were heated to 100° C. for three hours. No bubbling and leaking was observed. The channel was injected with PCR solution using the PCR protocol presented above. The chip was heated, and infrared images were taken at IX magnification using an Infrascope (EDO Corporation). The radiance images were checked every 5 minutes to observe if any air bubbles were being formed. FIG. 21A-B shows the infrared and temperature images at 40 and 300 minutes of heating at 95° C. The images show the uniform of temperature distribution at 95° C. with the PCR solution filled in the microchannels. The radiance images also clearly show the difference between the air spot close to the channel and filled PCR solution in the channel. At 95° C., the microchannels could hold the PCR solution for at least five hours without generating any bubble and leaking.

Heating Dynamics of the Flexible Parylene Based PCR on-Line Chip.

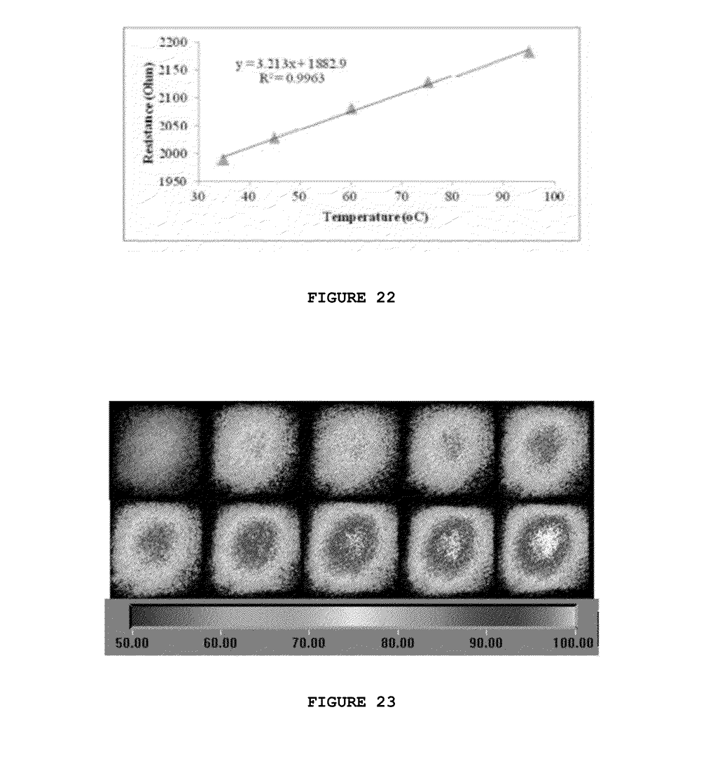

Before performing the on-chip PCR, the free-standing 20 nm Ti/200 nm Pt microheaterlsensor on parylene C film was characterized. The temperature coefficient of resistance (TCR) of the microsensor was characterized using the oven (Delta Design 2300) and calculated using the protocol presented above. The resistances at the temperature in between 35° C. to 95° C., covering the PCR operational range, were measured. After the chip was put into the oven and waited 3 times of the heating time constant, low input voltage was applied and the output current was read from Universal Source (RP 3245A). The resistance was calculated using Eq. 1 and plotted in FIG. 22. A TCR of 1.6E-3/° C. was achieved.

The on-chip heating uniformity was checked using an infrared microscope. The free-standing microheater and micro channel were glued together using thermal grease. The complete micro-PCR device was supplied with the input power both in transient and equilibrium modes. The integrated device showed good uniform heating area in the targeted fluorescence detecting zone.

PCR Experiments Using a Flexible Parylene Based PCR on-Line Chip.

The PCR mixture consists of IX Quanta PerfeCTa™ MultiPlex qPCR SuperMix (Quanta Biosciences) and primers having the sequences described above. Before loading PCR solution, the parylene channels were cleaned with DNA decontamination solution (Ambion) and rinsed with DEPC-treated and sterile filtered water (Sigma Aldrich). The fluids were manually injected using a micro syringe (Hamilton) with the PDMS and machined acrylic gasket. The PCR solution was well-mixed and centrifuged until there were no visible bubbles. The first channel was then loaded with the PCR solution and the second channel was filled with the ROX reference passive dye working as a control.

Approximately 2 nl of the PCR mixture with about 100 molecules of starting template was targeted at the 10× magnification fluorescence detecting zone. The microchannels were sealed by the same clamping technique. On-chip PCR experiments were performed using protocols as described above. The free-standing microheater and microchannel were glued together using thermal grease. The PCR thermal cycling started with 95° C. for 3 minutes, followed by 37 cycles of 95° C. for 15 seconds (denaturation) and 60° C. for 90 seconds (annealing/extension) respectively.

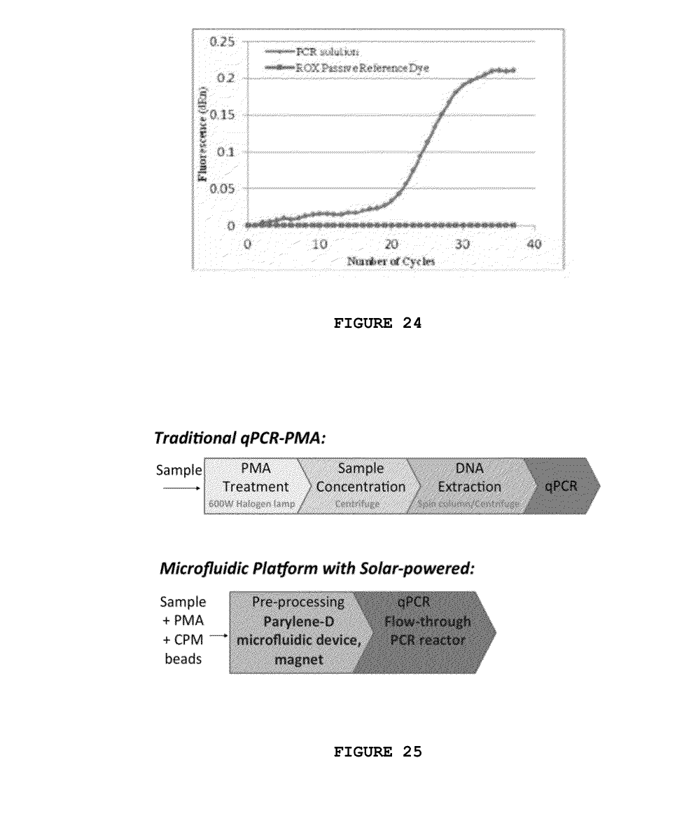

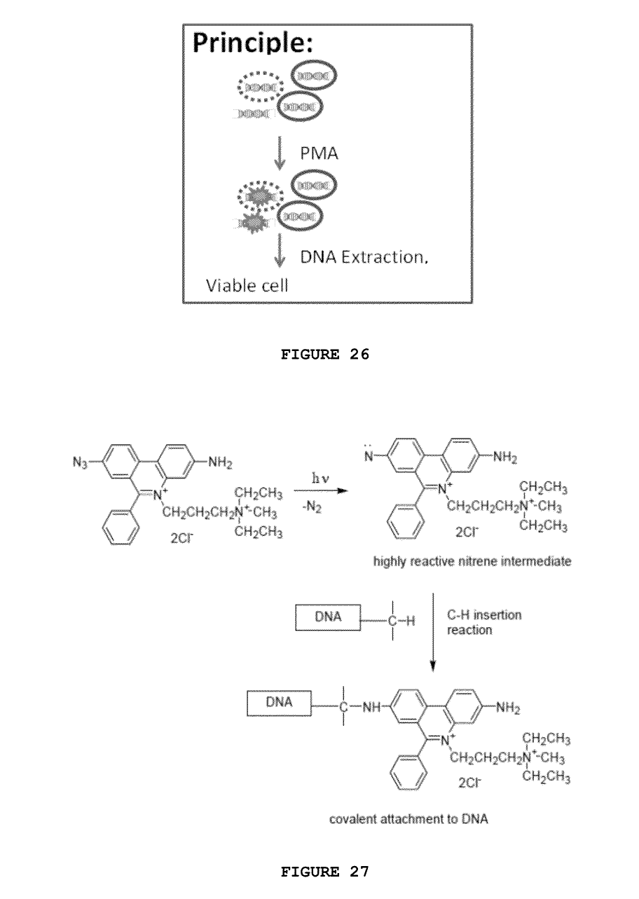

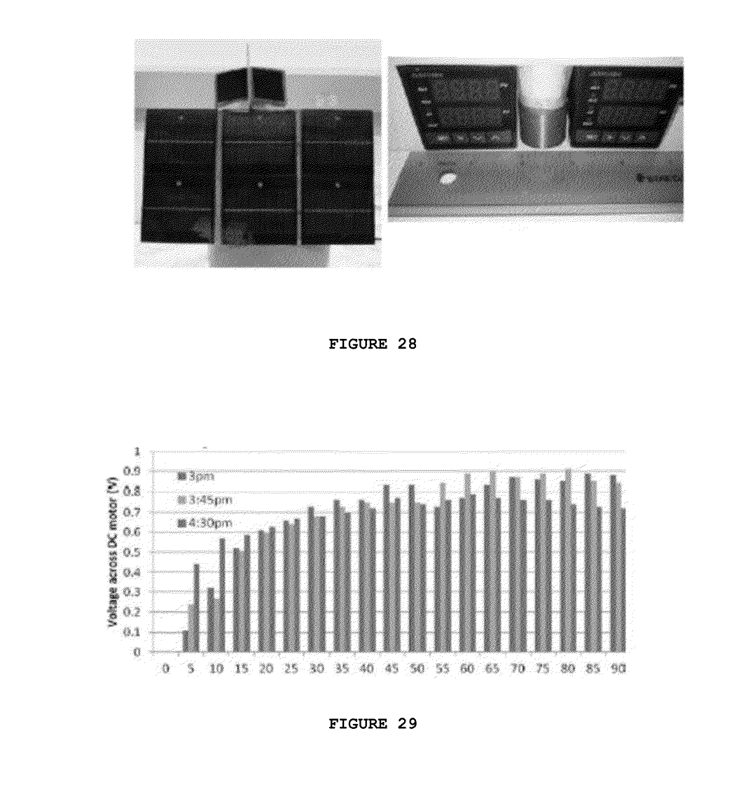

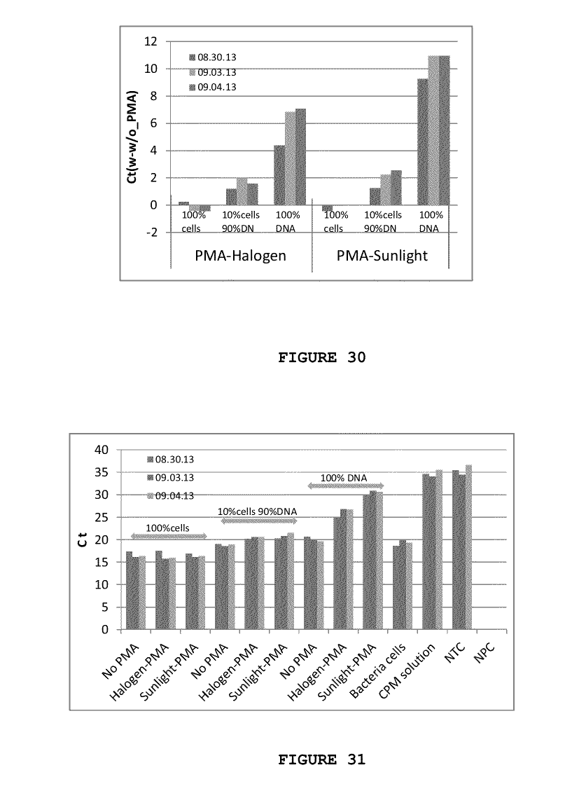

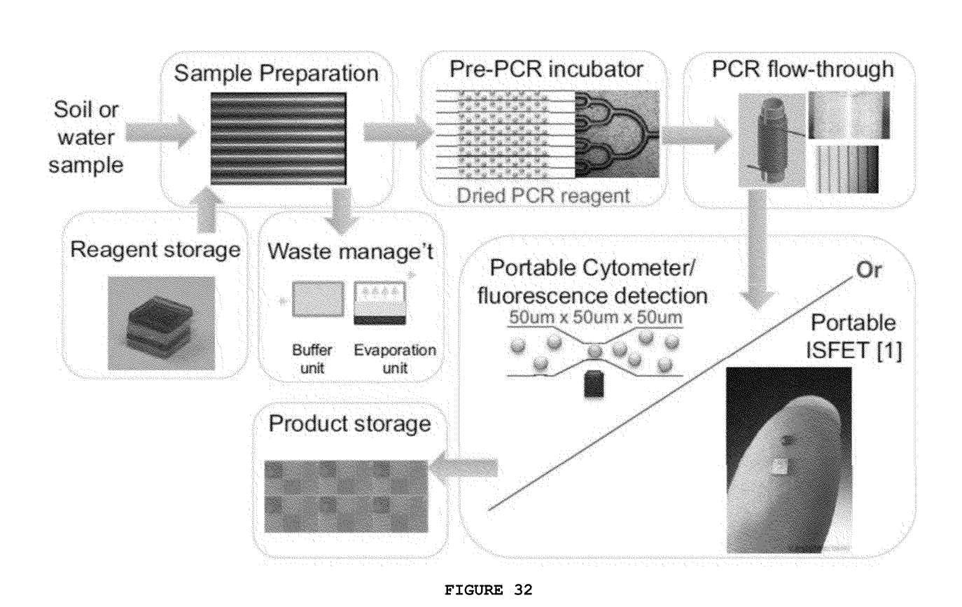

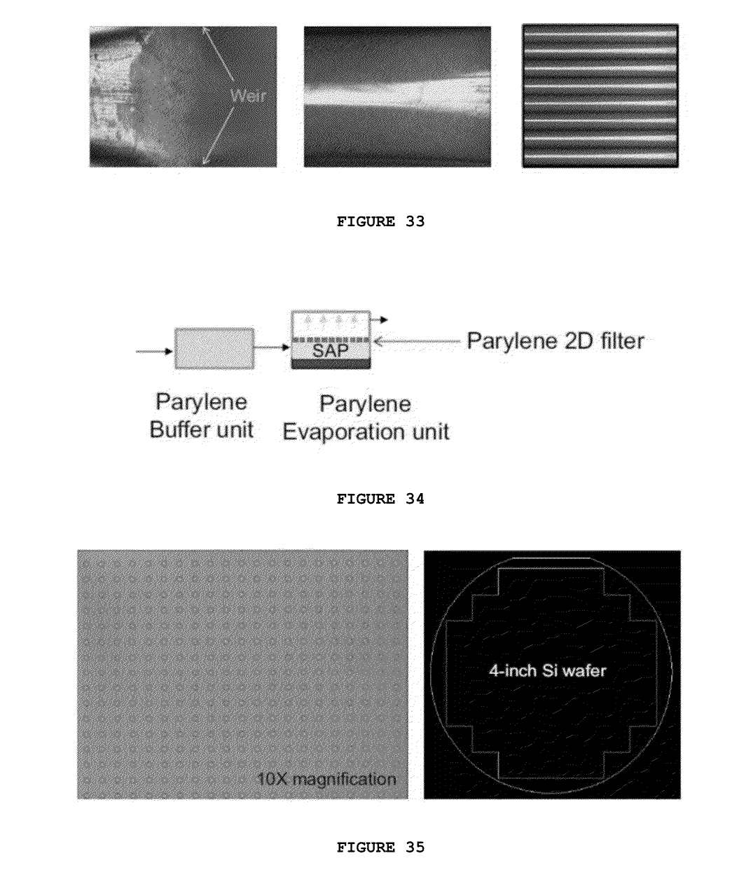

The free-standing Ti/Pt resistor was used as both the heater and temperature sensor. The voltage was supplied from HP 3245A Universal Source to the chip and the current was measured with a precision Agilent 34401A multimeter. The Lab View PID feedback control program was used to control the PCR thermal cycling. The fluorescence images (e.g., see FIG. 23) were taken under the fluorescence microscope at the end of each 37 thermal cycles with 10× magnification using a Nikon Eclipse E800 fluorescence microscope. The obtained fluorescence intensity from PCR channel was normalized against the ROX channel and parylene background. FIG. 24 shows the amplification fluorescence intensity. There was no bubbling and leaking during the on-chip PCR testing. We successfully obtained a PCR amplification curve comparable to that of a conventional real time PCR machine.

“All in One” Free-Standing Parylene Based PCR Chip Device:

A free-standing parylene based PCR device was developed to be an “all in one device,” allowing for sample preparation, DNA purification and PCR amplification in a single chip (e.g., see FIGS. 37 and 46). By simply loading samples into the chip device, PCR products could be generated in as little as an hour.

Sample Loading and Generation of PCR Products:

(1) 5-minute Sunlight PMA photoactivation. Sample (1 mL) is drawn into a syringe containing PMA dye. The mixed PMA-sample is then injected into the Parylene based chip. The optically transparent Parylene allows PMA photoactivation in situ. PMA photoactivation using sunlight provides comparable results to photoactivation by halogen light. The PMA treated solution then moves into the next zone by gravity and capillary force.
(2) 20-minute sample concentration and DNA purification. The chip allows for the simultaneous concentration of the sample and the extraction of DNA, by heating at 100° C. and using amphiphobic-treated Parylene with posts. The heating area has been optimized to yield 100 μL of DNA in less than 20 minutes. The CPM beads preloaded on-chip with magnet underneath capture PCR inhibitors providing purified DNA for the next section.
(3) 30-minute thermosiphon digital PCR. 100-μL purified DNA is mixed with the preloaded SAP containing PCR reagent. SAP has swollen capacity providing easy mixing and digital reading on-chip without using droplet generators or micro-patterning. Thermosiphon PCR allows automated fluid circulation through 95° C. and 55° C. zones without the need of pumps or valves. After 40 cycles, an image of the PCR product is taken with a cell phone camera. Image processing software is then used to calculate if there was a positive amplification. The quantitative result is sent to users by text or email.

Fabricating a Parylene Based Solar Powered PCR on-Chip Device that is Capable of Differentiating Between Live and Dead Cells.

First, Parylene-D is deposited on a mold. Then, the device is released from the mold. Next, 70-100 micropores are created on the Parylene device using a microneedle roller. The column is sized to limit to the purified DNA volume. The fabrication process requires no photolithography or time-consuming etching. The device can evaporate 1-mL solutions in less than 30 minutes and is capable of concentrating the target solution. The Parylene-D device can withstand continuous heating at 100° C. without cracking. The transparency of Parylene-D allows on-chip PMA photoactivation. As Parylene-D is hydrophobic but oleophilic, it is primed with oil to help concentrate the target solution.

Testing Super Absorbent Polymer (SAP) for Use in the Parylene Based Devices as a Bioreactor.

Micro poly-acrylic acid sodium salt SAP:

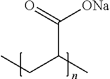

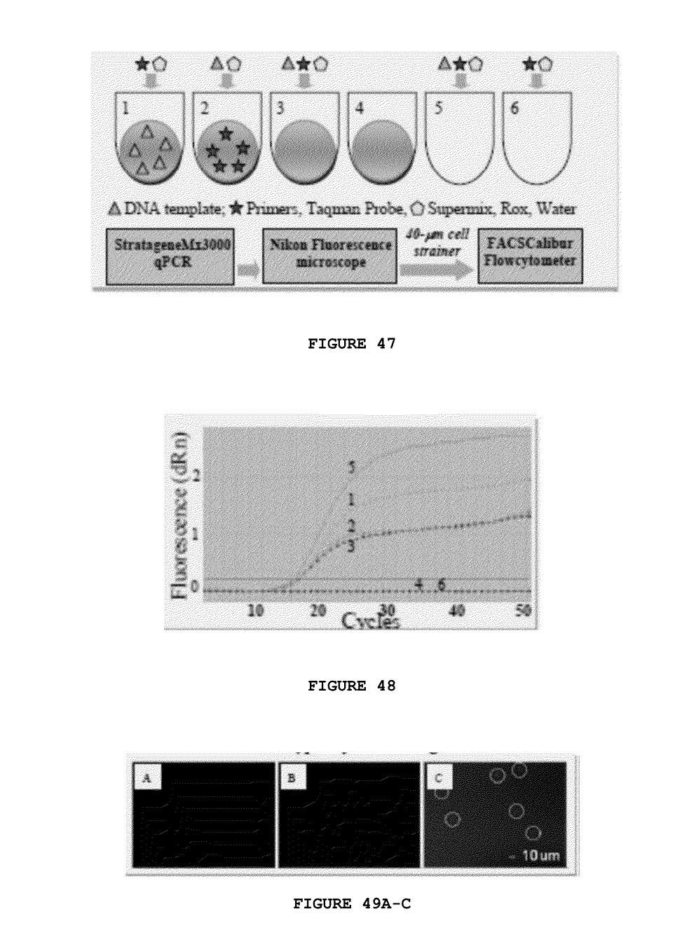

beads were tested for compatibility with PCR in four situations (FIG. 47) using a StratageneMx3000 qPCR machine. Taqman probe was used for specific binding to the target DNA fragment. The encapsulation protocols and techniques used were the same as those described in the literature. Secondly, the SAP beads with PCR reagents and DNA samples went through qPCR reactions and were examined afterwards under a Nikon Fluorescence microscope. Finally, these SAP beads were analyzed quantitatively by FACSCalibur Flow Cytometer. In addition, Visiblue (a PCR dye) was tested for its compatibility with SAP and PCR for easy on-chip reaction monitoring.

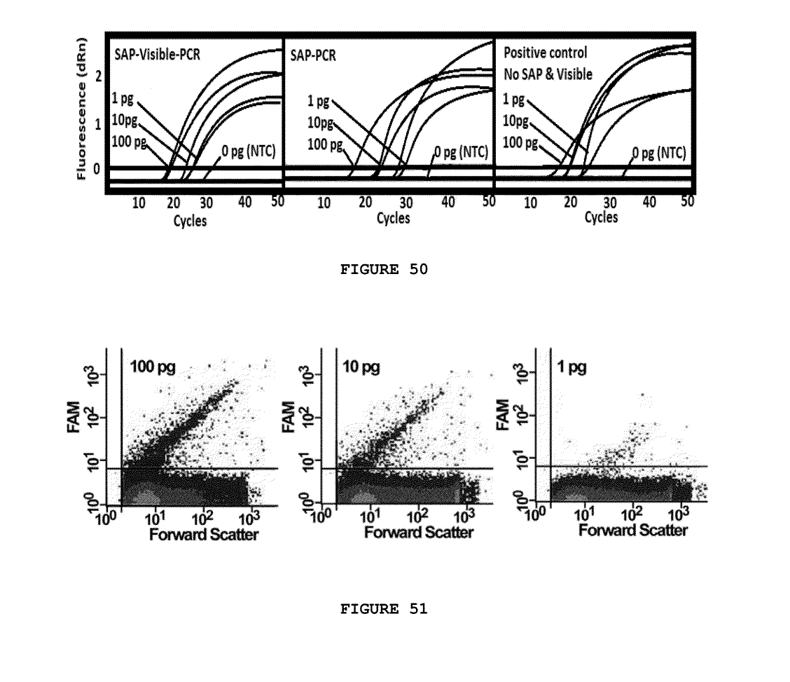

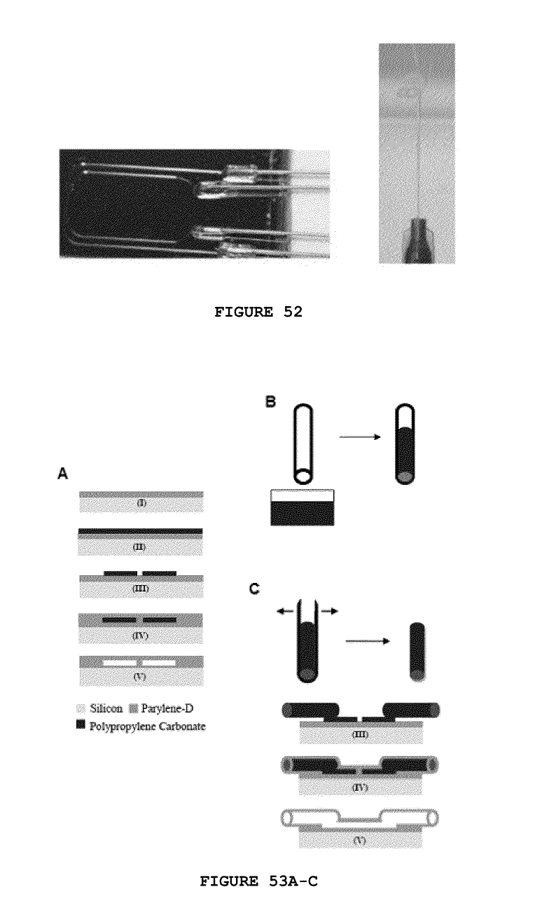

The results show that SAP is compatible with PCR and suitable for droplet digital PCR applications because of the similar Ct values of various types of starting reagent encapsulation from qPCR machine (e.g., see FIGS. 48 and 50); green emission of FAM probe labeled PCR products under blue excitation of fluorescence microscope (e.g., see FIG. 49); and flow cytometric signal from flow cytometer (e.g., see FIG. 51). Due to the required protocol of using 40-micron cell strainers before running SAP bioreactors through the flow cytometer cell, a lot of SAP beads were lost. In addition, only 250,000 SAP beads were sorted for each reaction due to limited machine availability. However, this preliminary result confirms the compatibility of SAP with PCR. The ongoing integrated detector will eliminate this problem and increase the accuracy and efficiency of the quantitative analysis of the platform.

TABLE 1
Poisson's statistic predicted and flow cytometer's
actual positive SAP-PCR bioreactors count.

| | | PREDICTED POSITIVE | ACTUAL POSITIVE |
|---|---|---|---|
| 18S | | COUNT (1 OR MORE | COUNT (1 OR MORE |
| rRNA | λ | COPIES) (%) | COPIES) (%) |
| 100 pg | 0.5 | 39.3 | 1.36 (3392/250K) |
| 10 pg | 0.05 | 4.87 | 0.67 (1670/250K) |
| 1 pg | 0.005 | 0.49 | 0.11 (277/250K) |

The results indicate that a simple, high sensitivity, light-weight, portable biosignatures analyzer can benefit by using SAP as a bioreactor.

Fabricating a Parylene Based Reservoirs.

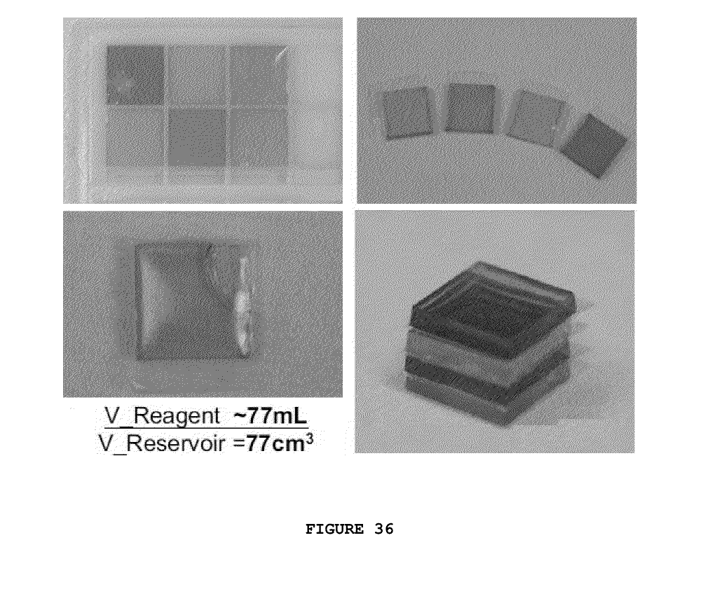

A form is generated or identified that comprises a depression or well. The form is then coated with parylene to desired thickness (e.g., 40 μm). After which, a liquid is added to the coated well. On top of the liquid, a layer of parylene is added. The liquid is then evaporated away leaving the parylene based reservoir (e.g., see FIG. 36).

A number of embodiments have been described herein. Nevertheless, it will be understood that various modifications may be made without departing from the spirit and scope of this disclosure. Accordingly, other embodiments are within the scope of the following claims.

1. A method of generating a liquid handling device, comprising:
forming a device precursor having a containment structure that defines a containment gap that is occupied by a solid sacrificial layer; and
removing the solid sacrificial layer from the containment gap,
a longitudinal axis of the containment gap being in the containment gap and being parallel to a direction that a liquid flows through the containment gap during operation of the device,
the containment structure surrounding the longitudinal axis of the containment gap.

2. The method of claim 1, wherein removing the solid sacrificial layer includes decomposing the solid sacrificial layer.

3. The method of claim 2, wherein decomposing the sacrificial layer includes performing a thermal decomposition of the sacrificial layer.

4. The method of claim 3, wherein the thermal decomposition is performed at a temperature less than 250° C.

5. The method of claim 1, wherein forming the device precursor includes forming a containment layer on the solid sacrificial layer such that the containment structure includes at least a portion of the containment layer and a surface of the containment layer defines at least a portion of the containment gap.

6. The method of claim 5, wherein the surface of the containment layer defines the entire containment gap.

7. The method of claim 5, wherein forming the device precursor includes forming a second containment layer on a substrate such that the containment structure includes at least a portion of the second containment layer and a surface of the second containment layer defines at least a portion of the containment gap,
the second containment layer being formed before forming the containment layer, and
the containment layer being formed over at least a portion of the second containment layer such that second containment layer is between the base and the containment layer.

8. The device of claim 7, wherein the containment layer and the second containment layer are the same material.

9. The device of claim 5, wherein the containment layer includes a containment polymer.

10. The device of claim 9, wherein the containment polymer is parylene.

11. The device of claim 9, wherein the parylene is represented by; 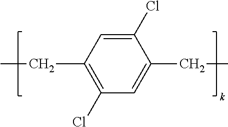
wherein k is greater than or equal to 2.

12. The device of claim 11, wherein the sacrificial layer includes a sacrificial polymer.

13. The device of claim 12, wherein the sacrificial polymer is a poly(alkylene carbonate).

14. The device of claim 12, wherein the sacrificial polymer is polypropylene carbonate.

15. The device of claim 1, wherein the sacrificial polymer is polypropylene carbonate.

16. The device of claim 1, wherein the containment gap has at least one dimension less than 500 μm where the dimension is selected from a group consisting of width, height, or diameter.

17. A liquid handling device, comprising:
a containment structure having a surface that defines a containment gap,
a longitudinal axis of the containment gap being in the containment gap and being parallel to a direction that the liquid flows through the containment gap during operation of the device,
the containment gap surrounding the longitudinal axis; and
at least a portion of the containment structure that defines the containment gap including a polymer represented by; 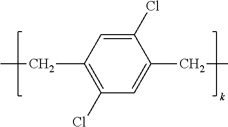
wherein k is greater than or equal to 2.

18. A method of generating a liquid handling device, comprising:
forming a device precursor having a containment structure that defines a containment gap that is occupied by a solid sacrificial layer; and
removing the solid sacrificial layer from the containment gap,
the containment gap structured so a first plane can be located such that an intersection of the first plane and the containment structure surrounds the containment gap, and
the containment gap structured so a second plane that is perpendicular to the first plane can be located such that an intersection of the second plane and the containment structure surrounds the containment gap.

19. A liquid handling device, comprising:
a containment structure having a surface that defines a containment gap,
the containment gap structured so a first plane can be located such that an intersection of the first plane and the containment structure surrounds the containment gap, and
the containment gap structured so a second plane that is perpendicular to the first plane can be located such that an intersection of the second plane and the containment structure surrounds the containment gap; and
at least a portion of the containment structure that defines the containment gap including a polymer represented by; 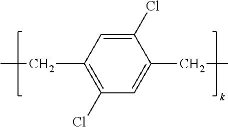
wherein k is greater than or equal to 2.

20. A liquid flow structure, comprising:
a fluid conduit configured to transport a liquid; and
a core including multiple heaters, the fluid conduit passing around the core multiple times so as to form multiple coils, each coil passing once around the core,
at least a portion of the coils each being arranged such that a fluid flowing through the coil is exposed to thermal energy from two or more of the heaters.


SEQUENCE LISTING (3 sequences)

SEQ ID NO: 1 - DNA, 24 bp, Artificial Sequence
  Oligonucleotide Primer - forward primer
ggagaggctattcggctatgactg

SEQ ID NO: 2 - DNA, 25 bp, Artificial Sequence
  Oligonucleotide primer - reverse primer
atactttctcggcaggagcaaggtg

SEQ ID NO: 3 - DNA, 29 bp, Artificial Sequence
  Oligonucleotide Probe
tagcagccagtcccttcccgcttcagtga